(19) United States
(12) Patent Application Publication
(10) Pub. No.: US 2026/0148983 A1
(43) Pub. Date: May 28, 2026

(54) ELECTROCHEMICALLY ACTIVE CATHODE MATERIAL

(71) Applicant: DURACELL U.S. OPERATIONS, INC., Wilmington, DE (US)

(72) Inventors: Paul A. Christian, Bethel, CT (US); Sanjeev Sharma, Bethel, CT (US); Jason Adinolfi, Wilmington, DE (US)

(21) Appl. No.: 19/397,591

(22) Filed: Nov. 21, 2025

Related U.S. Application Data
(60) Provisional application No. 63/724,205, filed on Nov. 22, 2024.

(51) Int. Cl. H01M 4/525; C01G 53/50; C01G 53/82; H01M 10/04; H01M 10/052; H01M 50/609

(52) U.S. Cl. CPC H01M 4/525; C01G 53/50; C01G 53/82; H01M 10/049; H01M 10/052; H01M 50/609; C01P 2002/50; C01P 2002/72; C01P 2004/61; C01P 2004/62; C01P 2004/64; C01P 2006/40

(57) ABSTRACT

Batteries including electrochemically active cathode materials comprising a stabilized non-stoichiometric delithiated layered nickel-metal composite oxide having a layered crystal structure, wherein the electrochemically active cathode material includes about 2.5 mol % to less than about 50 mol % of a second metal ion relative to the total non-alkali metal content, and methods of preparing and using same.

### FIELD

The disclosure relates generally to an electrochemically active cathode material and, more specifically, relates to a delithiated layered nickel oxide electrochemically active material having a portion of nickel ions substituted with a second metal ion and a battery including same.

### BACKGROUND

Electrochemical cells, or batteries, are commonly used as electrical energy sources. A battery contains a negative electrode, typically called the anode, and a positive electrode, typically called the cathode. The anode contains an electrochemically active anode material that can be oxidized. The cathode contains an electrochemically active material that can be reduced. The electrochemically active anode material is capable of reducing the electrochemically active cathode material. A separator is disposed between the anode and the cathode. An ionically conductive electrolyte solution is in intimate contact with the cathode, the anode, and the separator. The battery components are disposed in a can, or housing, that is typically made from metal.

When a battery is used as an electrical energy source in an electronic device, electrical contact is made to the anode and the cathode, allowing electrons to flow through the device and permitting the respective oxidation and reduction reactions to occur to provide electrical power to the electronic device. An electrolyte is in contact with the anode, the cathode, and the separator. The electrolyte contains ions that flow through the separator between the anode and cathode to maintain charge balance throughout the battery during discharge.

There is a growing need to make batteries that are better suited to power contemporary electronic devices. To meet this need, batteries may include higher loading of electrochemically active anode and/or cathode materials to provide increased capacity and service life. Batteries, however, also come in common sizes, such as the AA, AAA, AAAA, C, and D battery sizes, that have fixed external dimensions and constrained internal volumes. The ability to increase electrochemically active material loading alone to achieve better performing batteries is thus limited.

The electrochemically active cathode material of the battery may be formulated in order to provide increased performance. For example, incorporating an electrochemically active material that has relatively higher volumetric and gravimetric capacity may result in a better performing battery. Similarly, electrochemically active material that has a higher oxidation state may also result in a better performing battery. The electrochemically active material, however, must provide power at an acceptable closed circuit voltage, or running voltage, range in order to effectively power the devices. The device may be damaged if the open-circuit voltage (OCV) or running voltages of the battery are too high. Conversely, the device may not effectively function if the running voltage of the battery is too low.

Moreover, electrochemically active cathode materials, such as a high oxidation state transition metal oxides, may be highly reactive. The highly reactive nature of such an electrochemically active cathode material may lead to gas evolution when the electrochemically active cathode material is incorporated within a battery and is brought into contact with the electrolyte solution. Any gas that is evolved may lead to an increase in pressure within the battery, possibly resulting in structural integrity issues, such as continuity within the cathode, and/or leakage of electrolyte from the battery. The high oxidation state transition metal oxide may react with the electrolyte, which may lead to other structural issues within the battery, such as cathode swelling, and consumption of water resulting in an unfavorable water balance within the battery, thereby decreasing battery performance as well as battery life. Also, a battery including a high oxidation state transition metal oxide as an electrochemically active cathode material may, for example, exhibit thermodynamic instability and exhibit an elevated rate of self-discharge when the battery is stored for an extended period of time.

Further, high oxidation state transition metal oxides often include relatively expensive metals such as nickel. While less expensive metals have been incorporated into high oxidation state transition metal oxides, it has been shown that the substitution of relatively inexpensive metals, such as manganese, for nickel, even at relatively low manganese amounts, can lead to significantly diminished discharge capacity relative to the corresponding nickel oxide material comprising only nickel atoms (i.e., in which there is no substitution of nickel ions with second non-alkali metal ions). See Xu et al., Electrochimica Acta, 2022, 417, 140345 (showing a reduction in low-rate capacity of approximately 20% at 6 mol % Mn); see also Guimard et al., J. Electrochem. Soc. 2003, 150, A1287-A1293 (showing a reduction in reversible capacity of approximately 20% at 10 mol % Mn). Further still, as described in U.S. Pat. No. 10,910,647, non-stoichiometric alkali metal-deficient layered nickel oxide, which is an electrochemically active cathode material including a high oxidation state nickel, when doped with an alkaline earth metal, main group metal, or a transition metal, M, in an amount greater than or equal to 20% of the amount of nickel does not form a stable layered structure upon passivation and, instead, forms a gamma-nickel oxyhydroxide structure.

### SUMMARY

In one aspect, the disclosure provides a battery comprising an anode, a cathode, and a separator between the anode and the cathode, wherein the cathode comprises an electrochemically active cathode material comprising a beta-delithiated layered nickel-metal composite oxide having a layered crystal structure, the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to less than about 50 mol % of the second metal ion relative to the total non-alkali metal content, and wherein the electrochemically active cathode material has a volumetric energy density greater than about 1900 Wh/L.

In another aspect, the disclosure provides an electrochemically active cathode material comprising a beta-delithiated layered nickel-metal composite oxide having a layered crystal structure, the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to less than about 50 mol % of the second metal ion relative to the total non-alkali metal content.

In an additional aspect, the disclosure provides a method of preparing an electrochemically active cathode material having a layered crystal structure, the method comprising (a) admixing a nickel metal hydroxide, nickel metal carbonate, a nickel metal nitrate, a nickel metal acetate, a nickel metal citrate, or a combination thereof with a lithium salt to form a reaction mixture; (b) calcining the reaction mixture to form a non-stoichiometric lithium nickel-metal composite oxide having a layered crystal structure; and (c) further processing the non-stoichiometric lithium nickel-metal composite oxide to form a beta-delithiated layered nickel-metal composite oxide having a layered crystal structure, the beta-delithiated layered nickel-metal composite oxide layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, and wherein the electrochemically active cathode material includes about 2.5 mol % to less than about 50 mol % of the second metal ion relative to the total non-alkali metal content.

In yet another aspect, the disclosure provides a method of preparing a battery comprising preparing a cathode material comprising admixing a nickel metal carbonate with lithium salt to form a mixture and annealing the mixture under oxygen flow, wherein the metal, M, of the nickel metal carbonate comprises Mn, Fe, Al, or a combination thereof; incorporating the cathode material into a cathode; incorporating the cathode into the battery; incorporating an anode into the battery; and incorporating an electrolyte into the battery.

In another aspect, the disclosure provides a method of preparing an electrochemically active cathode material having a layered crystal structure, the method comprising: (a) admixing a nickel nitrate, a metal nitrate, and a lithium nitrate to form a mixture; (b) annealing the mixture under a flow of oxygen to form a non-stoichiometric lithium nickel-metal composite oxide having a layered crystal structure; and (c) further processing the non-stoichiometric lithium nickel-metal composite oxide to form a beta-delithiated layered nickel-metal composite oxide having a layered crystal structure, the beta-delithiated layered nickel-metal composite oxide layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to less than about 50 mol % of the second metal ion relative to the total non-alkali metal content.

In yet another aspect, the disclosure provides a method of preparing a battery comprising: preparing a cathode material comprising admixing a nickel nitrate, a metal nitrate, and a lithium salt to form a mixture and annealing the mixture under oxygen flow, wherein the metal, M, of the nickel metal carbonate comprises Mn, Al, Fe, or a combination thereof; incorporating the cathode material into a cathode; incorporating the cathode into the battery; incorporating an anode into the battery; and incorporating an electrolyte into the battery.

Further aspects and advantages will be apparent to those of ordinary skill in the art from a review of the following detailed description. While the compositions and methods are susceptible of embodiments in various forms, the description hereafter includes specific embodiments with the understanding that the disclosure is illustrative, and is not intended to limit the disclosure to the specific embodiments described herein.

### BRIEF DESCRIPTION OF THE DRAWINGS

While the specification concludes with claims particularly pointing out and distinctly claiming the subject matter, which is regarded as forming the present invention, it is believed that the invention will be better understood from the following description taken in conjunction with the accompanying drawings.

FIG. 1 is a cross-section of an embodiment of a primary alkaline battery including a beta-delithiated layered nickel-metal composite oxide electrochemically active cathode material of the disclosure.

FIG. 2 illustrates XRD spectra for electrochemically active cathode materials of the disclosure.

FIG. 3 are plots of gassing over time for beta-delithiated layered nickel-metal composite oxide electrochemically active cathode materials of the disclosure relative to a control beta-delithiated layered nickel oxide material comprising only nickel atoms (i.e., in which there is no substitution of nickel ions with second non-alkali metal ions).

FIG. 4A are plots of discharge capacity for batteries including the electrochemically active cathode materials of the disclosure, relative to control batteries including two known materials, a beta-delithiated layered nickel oxide material comprising only nickel atoms (i.e., in which there is no substitution of nickel ions with second non-alkali metal ions) and electrolytic manganese dioxide, as the electrochemically active cathode materials, respectively.

FIG. 4B are plots of discharge capacity for a battery including the electrochemically active cathode materials of the disclosure and a battery including a beta-delithiated layered nickel manganese oxide contaminated with high amounts (>10%) of gamma nickel oxyhydroxide, as the electrochemically active cathode materials.

FIG. 4C is an expanded view of FIG. 4A for voltages above 1.40 V.

FIG. 5 illustrates XRD spectra of a beta-delithiated layered nickel manganese composite oxide electrochemically active cathode material of the disclosure and ramsdellite manganese dioxide.

FIG. 6 are XRD spectra of a beta-delithiated layered nickel manganese composite oxide electrochemically active cathode material of the disclosure and manganese-substituted (or “Mn-doped”) delithiated nickel oxides prepared according to prior art methods.

### DETAILED DESCRIPTION

Electrochemical cells, or batteries, may be primary or secondary. Primary batteries are meant to be discharged, e.g., to exhaustion, only once and then discarded. Secondary batteries are intended to be recharged. Secondary batteries may be discharged and recharged many times, e.g., more than fifty times, a hundred times, or more. Primary and secondary batteries are described, for example, in David Linden, Handbook of Batteries (4^{th} ed. 2011). It is understood that batteries may include various electrochemical couples and electrolyte combinations. Although the description and examples provided herein are generally directed towards primary alkaline electrochemical cells, or batteries, it should be appreciated that the invention applies to both primary and secondary batteries having aqueous, nonaqueous, ionic liquid, and solid state electrolyte systems. Primary and secondary batteries including the aforementioned electrolytes are thus within the scope of this application and the invention is not limited to any particular embodiment.

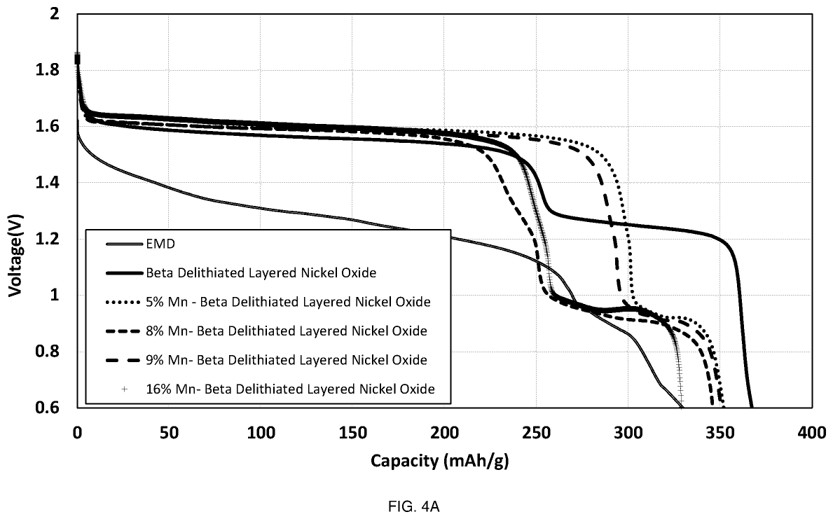

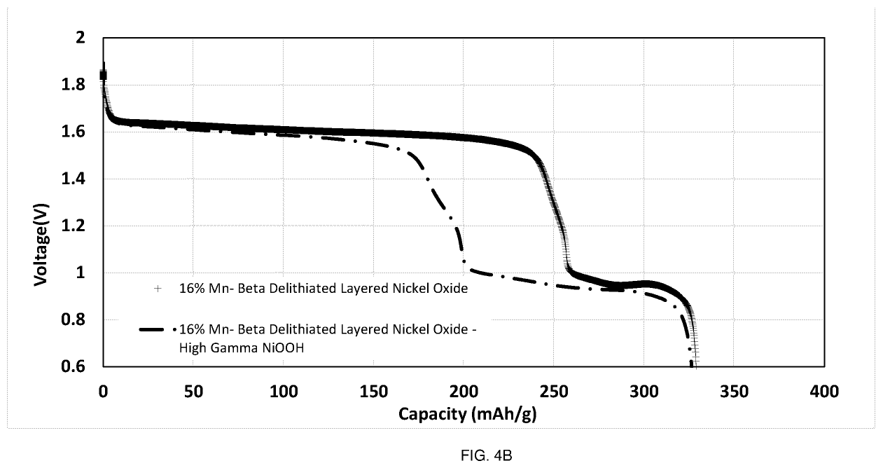

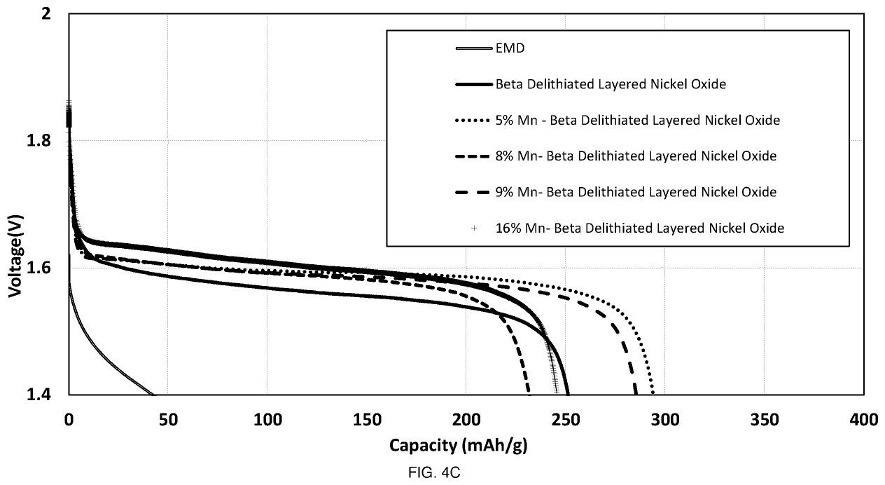

The disclosure provides an electrochemically active cathode material comprising a beta-delithiated layered nickel-metal composite oxide having a layered crystal structure, the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, and wherein the electrochemically active cathode material includes about 2.5 mol % to less than about 50 mol % of the second metal ion relative to the total non-alkali metal content. With respect to the beta-delithiated layered nickel-metal composite oxide disclosed herein, it was surprisingly and unexpectedly found that, when a second metal, particularly manganese, that is known to be less electrochemically active than nickel, is included in a nickel-based electrochemically active material, as a mixed metal composite oxide, the reactivity of the electrochemically active material is significantly decreased, without a significantly detrimental decrease in capacity. Moreover, as described in more detail below, the beta-delithiated layered nickel-metal composite oxide disclosed herein is particularly useful for applications requiring power at a relatively high voltage at or above 1.40V. In this respect, as shown in FIG. 4C, the beta-demetallated layered nickel-metal composite oxides of the disclosure surprisingly delivered significantly more capacity than the control beta-demetallated layered nickel-metal oxide without the additional second metal, M, in a voltage window between 1.4 V and 1.65 V.

As used herein term “mixed metal composite oxide” refers to a layered metal oxide structure including two or more metal ions selected from alkaline earth metals, transition metals, main group metals, or combinations thereof, wherein the two or more metal ions are randomly interspersed throughout the layered metal oxide structure, rather than each metal ion being concentrated in one area of the layered metal oxide or a bulk material including a mixture of two or more distinct metal oxides. In the mixed metal composite oxides disclosed herein, one of the metal ions is nickel. The second metal ion can be chosen from one or more in the group of manganese ion, aluminum ion, magnesium ion, titanium ion, vanadium ion, chromium ion, copper ion, zinc ion, iron ion, and cobalt ion.

The term “about” is used according to its ordinary meaning, for example, to mean approximately or around. In one embodiment, the term “about” means±10% of a stated value or range of values. In another embodiment, the term “about” means±5% of a stated value or range of values. A value or range described in combination with the term “about” expressly includes the specific value and/or range as well (e.g., for a value described as “about 40,” “40” is also expressly contemplated).

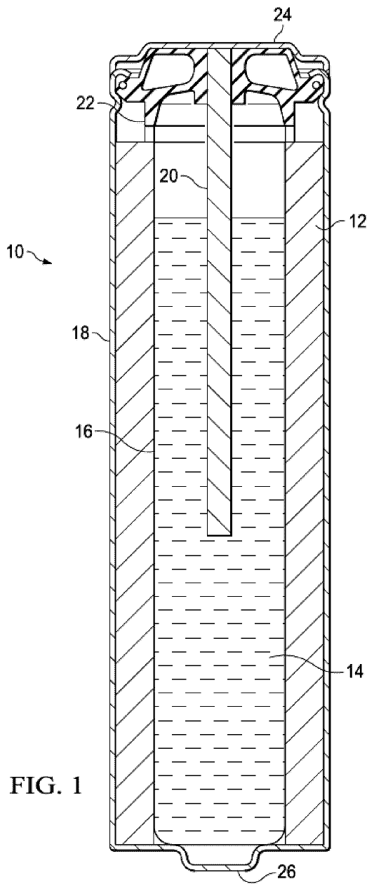

Referring to FIG. 1, there is shown a primary alkaline electrochemical cell, or battery, 10 including a cathode 12, an anode 14, a separator 16, and a housing 18. Battery 10 also includes a current collector 20, a seal 22, and an end cap 24. The end cap 24 serves as the negative terminal of the battery 10. A positive pip 26 is at the opposite end of the battery 10 from the end cap 24. The positive pip 26 may serve as the positive terminal of the battery 10. An electrolyte is dispersed throughout the battery 10. The cathode 12, anode 14, separator 16, electrolyte, current collector 20, and seal 22 are contained within the housing 18. Battery 10 can be, for example, a AA, AAA, AAAA, C, or D size alkaline battery, or a button cell or coin cell.

The housing 18 can be of any conventional type of housing commonly used in primary alkaline batteries and can be made of any suitable base material, for example cold-rolled steel or nickel-plated cold-rolled steel. The housing 18 may have a cylindrical shape. The housing 18 may be of any other suitable, non-cylindrical shape. The housing 18, for example, may have a shape comprising at least two parallel plates, such as a rectangular, square, or prismatic shape. The housing 18 may be, for example, deep-drawn from a sheet of the base material, such as cold-rolled steel or nickel-plated steel. The housing 18 may be, for example, drawn into a cylindrical shape. The housing 18 may have at least one open end. The housing 18 may have a closed end and an open end with a sidewall therebetween. The interior surface of the sidewall of the housing 18 may be treated with a material that provides a low electrical-contact resistance between the interior surface of the sidewall of the housing 18 and an electrode, such as the cathode 12. The interior surface of the sidewall of the housing 18 may be plated, e.g., with nickel, cobalt, and/or painted with a carbon-loaded paint to decrease contact resistance between, for example, the internal surface of the sidewall of the housing 18 and the cathode 12.

### Electrochemically Active Cathode Material

The cathode 12 includes at least one electrochemically active cathode material. The electrochemically active cathode materials prepared according to the methods of the disclosure are referred to herein as “stabilized non-stoichiometric alkali metal-deficient layered nickel-metal composite oxides,” “stabilized non-stoichiometric demetallated layered nickel-metal composite oxides,” or “beta-demetallated layered nickel-metal composite oxides.” In embodiments, the alkali metal-deficient layered nickel-metal composite oxide can comprise a stabilized non-stoichiometric delithiated layered nickel-metal composite oxide, i.e., a beta-delithiated layered nickel-metal composite oxide. In preferred embodiments, the alkali metal-deficient layered nickel-metal composite oxide can comprise a stabilized non-stoichiometric delithiated layered nickel-manganese composite oxide, i.e., a beta-delithiated layered nickel-manganese composite oxide.

The beta-demetallated layered nickel-metal composite oxide electrochemically active cathode material may provide a gravimetric capacity when included in an alkaline 635 button cell as the sole electrochemically active cathode material. The beta-demetallated layered nickel-metal composite oxide electrochemically active cathode material may provide a gravimetric capacity greater than about 300 mAh/g, or greater than about 310 mAh/g, and/or greater than about 320 mAh/g, when an alkaline 635 button cell including the beta-demetallated layered nickel-metal composite oxide electrochemically active cathode material as the sole electrochemically active cathode material is discharged at a low discharge rate to a 0.6 V cutoff, as determined by the Low Rate Discharge Capacity Test disclosed herein. The beta-delithiated layered nickel-metal composite oxide electrochemically active cathode material may provide a gravimetric capacity from about 300 mAh/g to about 400 mAh/g, from about 310 mAh/g to about 380 mAh/g, from about 320 mAh/g to about 360 mAh/g, when an alkaline 635 button cell including the beta-demetallated layered nickel-metal composite oxide electrochemically active cathode material as the sole electrochemically active cathode material is discharged at a low discharge rate (e.g., <C/30 or <C/40) to a 0.6 V cutoff, as determined by the Low Rate Discharge Capacity Test disclosed herein. As shown in the Examples, the beta-demetallated layered nickel-metal composite oxide electrochemically active cathode materials disclosed herein surprisingly and advantageously demonstrate similar or superior battery performance, particularly with respect to volumetric energy, with significantly reduced reactivity, while incorporating less expensive materials, relative to control prior art materials.

Additionally, the beta-demetallated layered nickel-metal composite oxide electrochemically active cathode material may provide a gravimetric capacity in a voltage window of 1.40V to 1.65V of about 225 mAh/g to about 300 mAh/g, about 225 mAh/g to about 275 mAh/g, or about 250 mAh/g, when an alkaline 635 button cell including the beta-demetallated layered nickel-metal composite oxide electrochemically active cathode material as the sole electrochemically active cathode material is discharged at a low discharge rate (e.g., <C/30 or <C/40) to a 0.6 V cutoff), as determined by the Low Rate Discharge Capacity Test disclosed herein. Such advantageously high gravimetric capacities are beneficial for enhanced battery performance, particularly in applications requiring high voltage power.

As used herein, and unless specified otherwise, a “low discharge rate” refers to a fully charged battery that discharges over the course of about 30 to about 40 hours, i.e., a battery having about C/30 to about C/40 rate. The C-rate is a well understood measurement in the art that communicates the rate at which a battery is discharged relative to its theoretical rated capacity. It is defined as the discharge current divided by the theoretical discharge current under which the battery would deliver its total nominal/theoretical rated capacity in 1 hour. For example, a 1C discharge rate for a material having a gravimetric discharge capacity of about 420 mAh/g would deliver the total 420 mAh/g capacity in 1 hour. A 2C rate would deliver the total 420 mAh/g capacity in 0.5 hour. A C/2 rate would deliver the 420 mAh/g in 2 hours.

The beta-demetallated layered nickel-metal composite oxide electrochemically active cathode material may provide a volumetric energy density calculated according to the following formula: Volumetric Energy Density (Wh/L)=Discharge Energy (mWh/g)×True Density (g/cm³). The discharge energy can be determined by the Low Rate Discharge Capacity Test disclosed herein and the true density can be determined according to the methods disclosed herein. It is well understood in the art that a battery includes a finite volume that can be taken up by the electrochemically active cathode material. Thus, for a given volume, as the density of the electrochemically active cathode material increases, more active material can be provided in the battery, resulting in a higher volumetric energy density. Thus, the volumetric energy density can be a useful tool for predicting electrochemically active cathode material performance in actual cells and is based on actual electrochemical test results (typically, from a small format 635 button cell) as well as the material's true density. The beta-demetallated layered nickel-metal composite oxide electrochemically active cathode material may provide a volumetric energy density greater than about 1900 Wh/L, greater than about 1950 Wh/L, or greater than about 2000 Wh/L, when included as the sole electrochemically active cathode material in an alkaline 635 button cell that is discharged at a low discharge rate to a 0.6 V cutoff. The beta-demetallated layered nickel-metal composite oxide electrochemically active cathode material may provide a volumetric energy density in a range of about 1900 Wh/L to about 2500 Wh/L, about 1900 Wh/L to about 2400 Wh/L, about 1950 Wh/L to about 2400 Wh/L, about 1950 Wh/L to about 2350 Wh/L, or about 2000 Wh/L to about 2350 Wh/L, when an alkaline 635 button cell including the beta-demetallated layered nickel-metal composite oxide electrochemically active cathode material as the sole electrochemically active cathode material is discharged at a low discharge rate (e.g., <C/30 or <C/40) to a 0.6 V cutoff.

Additionally, the beta-demetallated layered nickel-metal composite oxide electrochemically active cathode material may provide a volumetric energy density in a range of about 1000 Wh/L to about 2000 Wh/L, about 1200 Wh/L to about 2000 Wh/L, or about 14000 Wh/L to about 2000 Wh/L, when an alkaline 635 button cell including the beta-demetallated layered nickel-metal composite oxide electrochemically active cathode material as the sole electrochemically active cathode material is discharged at a low discharge rate (e.g., <C/30 or <C/40) to a cutoff of 1.40V. Such advantageously high volumetric energy densities provide enhanced battery performance, particularly in applications requiring power at a relatively high voltage at or above 1.40V.

The beta-demetallated layered nickel-metal composite oxides are a stabilized form of a non-stoichiometric demetallated layered nickel-metal composite oxide (also referred to herein as “alpha-demetallated layered nickel-metal composite oxide” or “non-stoichiometric alkali-metal deficient layered nickel-metal composite oxide”). The alpha-demetallated layered nickel-metal composite oxides are prepared from a non-stoichiometric layered alkali nickel-metal composite oxide.

The non-stoichiometric layered alkali nickel-metal composite oxide precursor material has a general formula A₁₋ₐNi_{1-z+a}M_{z}O₂, wherein A is an alkali metal, M is an alkaline earth metal, main group metal, or a transition metal, 0.02≤a≤0.2, and 0.025≤z≤0.5.

As used herein, “non-stoichiometric” refers to layered alkali nickel-metal composite oxide materials wherein 1+a>1, such that the molar ratio of (Ni+M):Li>1. A can be selected from the group consisting of lithium, sodium, potassium, and a combination thereof. In embodiments, A comprises lithium. Without intending to be bound by theory, it is believed that the ionic radii of Rb⁺ and Cs⁺ are too large to allow these ions to be the primary alkali metal, A, as they are unable to form a stable layered structure having a structure equivalent to lithium nickel oxide or sodium nickel oxide.

The non-stoichiometric layered alkali nickel-metal composite oxide has a layered lattice structure that is generally isomorphic with the layered lattice structures of lithium nickel oxide or sodium nickel oxide. The lithium nickel oxide and sodium nickel oxide lattice structures are made up of stacks of NiO₂ layers having triangular symmetry and cubic close packing in an oxygen sublattice. The basic building block of the NiO₂ layer is a NiO₆ octahedron that shares its edges with other NiO₆ octahedra located in the same layer to form an extended edge-shared network. The alkali (lithium or sodium) ions are located in octahedral and/or tetrahedral sites, defined by the oxygen atoms, in an interlayer region between NiO₂ layers. The NiO₂ layers are systematically aligned relative to one another so as to form stacks of alternating NiO₂ layers and alkali-containing layers having long-range ordering. The NiO₂ layers of lithium nickel oxide and sodium nickel oxide consisting of NiO₆ octahedron are referred to herein as “ideal NiO₂ layers.” The non-stoichiometric layered alkali nickel-metal composite oxide similarly has a plurality of “NiO₂-type layers” which, as used herein, refers to nickel-metal composite oxide layers that are isomorphic with ideal NiO₂ layers but can comprise NiO₆ and MO₆ octahedra building blocks that share edges with other NiO₆ or MO₆ octahedron, such that a portion of nickel ion sites in a plurality of ideal NiO₂ layers are occupied by an additional second metal, M. The alkali ions of the non-stoichiometric layered alkali nickel-metal composite oxide reside in the octahedral and/or tetrahedral sites defined by the oxygen atoms, in the interlayer region between the NiO₂-type layers. These octahedral and/or tetrahedral sites in the interlayer region between NiO₂-type layers may also be referred to herein as “octahedral sites,” “tetrahedral sites,” “alkali sites,” or “lithium sites.” In addition to, or in the alternative to, the additional second metal, M, occupying some of the nickel ion sites, the metal, M, can occupy some of the alkali sites of the layered lattice structure.

The non-stoichiometric layered alkali nickel-metal composite oxide includes the metal, M, in sites that would otherwise be occupied by Ni ions and/or alkali ions in a pure alkali nickel oxide structure (e.g., LiNiO₂ or NaNiO₂). M can generally be an alkaline earth metal, a transition metal or a main group metal, wherein M can be present in an amount in a range of about 2.5% to less than about 50%, for example, about 5% to about 40%, about 10% to about 30%, or about 15% to about 25%, about 14% to about 22%, about 5% to about 20%, about 5% to about 16%, or about 30% to about 40% relative to the total non-alkali metal content. M can be present in an amount in a range of about 2.5 mol. % to about 25 mol. %, relative to the total non-alkali metal content. M can be present in an amount in a range of about 2.5 mol % to about 20 mol %, relative to the total non-alkali metal content. Thus, in the formula A₁₋ₐNi_{1-z+a}M_{z}O₂, z can be, 0.025≤z≤0.5, for example, 0.025≤z≤0.30, 0.025≤z≤0.25, 0.025≤z≤0.20, 0.025≤z≤0.125, 0.025≤z≤0.45, 0.05≤z≤0.4, 0.05≤z≤0.35, 0.075≤z≤0.3, 0.075≤z≤0.25, 0.075≤z≤0.2, 0.075≤z≤0.15, 0.05≤z≤0.5, 0.10≤z≤0.5, 0.20≤z≤0.5, or 0.14≤z≤0.22. In embodiments, 0.025≤z≤0.25. In embodiments, 0.025≤z≤0.20. In embodiments, 0.25<z≤0.5. In embodiments, M can be one or more second metals selected from manganese, aluminum, magnesium, titanium, vanadium, chromium, copper, zinc, iron, and cobalt. In some embodiments, M comprises manganese, magnesium, aluminum, iron, or a combination thereof. In a refinement, M does not include aluminum. Aluminum can be less preferred as it may promote formation of gamma-NiOOH during the stabilization step disclosed herein rather than the stabilized non-stoichiometric alkali metal-deficient nickel-metal composite oxide material. In some embodiments, M comprises manganese, magnesium, or a combination thereof. In some embodiments, M comprises manganese, iron, or a combination thereof. In some embodiments, M comprises iron. In some embodiments, M comprises manganese. The manganese, magnesium, aluminum, or iron can be present as Mn⁺⁴, Mg⁺³, Al⁺³, or Fe⁺³, respectively.

Without intending to be bound by theory, it is believed that the precipitation method disclosed herein for preparing the non-stoichiometric alkali nickel-metal composite oxide precursor can result in a statistically random distribution of metal, M, throughout the bulk material. Homogeneity of the bulk material can be determined by X-ray diffraction (XRD). A homogenous bulk material can comprise an XRD pattern for a single phase. For example, the XRD of the non-stoichiometric layered alkali nickel-metal composite oxides of the disclosure prepared according to methods of the disclosure are substantially pure and single phase and thus samples typically include a single XRD pattern and do not, for example, include an XRD pattern for a pure manganese phase or a pure nickel phase. The precipitation method can also provide a structural difference from an alkali nickel oxide that has been prepared using a traditional solid-state method, such as that disclosed in U.S. Pat. No. 9,028,564. In the prior-art solid-state method (hereinafter referred to as “doping”), oxide precursor material (e.g., β-NiOOH, Co₃O₄, and LiOH·H₂O) are mixed by high-energy milling and then heated to melt temperatures under flowing O₂ to allow diffusion of metal ions to form a final metal oxide structure. In practice, imperfect diffusion may occur leaving some precursor metal oxide phases (e.g., β-NiOOH and Co₃O₄) in the resulting material such that the resulting material is less homogeneous than the composite oxide material prepared according to methods of the disclosure.

Further, without intending to be bound by theory, it is believed that the solid state nitrate method disclosed herein for preparing the non-stoichiometric alkali nickel-metal composite oxide precursor can also result in a more statistically random distribution of metal, M, throughout the bulk material, relative to the prior-art solid-state method using oxide precursor materials. Without intending to be bound by theory, it is believed that because the nitrate starting materials (e.g., Ni(NO₃)·6H₂O, Mn(NO₃)₂·xH₂O, and LiNO₃) exhibit some melting during processing which allows for more homogeneous mixing, relative to a solid-state method using oxide precursor materials (e.g., β-NiOOH, Co₃O₄, and LiOH·H₂O) which do not melt but are merely physically admixed.

Without intending to be bound by theory, it is believed that as the amount of metal, M, in a non-stoichiometric alkali metal-containing layered nickel oxide and a non-stoichiometric alkali metal-deficient layered nickel oxide and/or stabilized non-stoichiometric alkali metal-deficient layered nickel oxide prepared therefrom increases, the stability of an electrochemically active material including the non-stoichiometric alkali metal-deficient layered nickel oxide and/or stabilized non-stoichiometric alkali metal-deficient layered nickel oxide to an aqueous hydroxide solution, such as an alkaline battery electrolyte, can increase but, along with any increase in stability, the total discharge capacity also tends to decrease. Further, as described in U.S. Pat. No. 10,910,647, a non-stoichiometric alkali metal-deficient layered nickel oxide doped with M in an amount greater than or equal to 20% of the amount of nickel does not form a stable layered structure upon passivation and, instead, a gamma-nickel oxyhydroxide structure is formed. As shown in Comparative Example 1 herein, replacing 50% of the nickel in a non-stoichiometric alkali metal-deficient layered nickel oxide with a second metal, M, relative to total nickel ion sites, leads to collapse of the layered structure and formation of a structure consistent with ramsdellite MnO₂.

In embodiments, the non-stoichiometric layered alkali nickel-metal composite oxide, 0.02≤a≤0.2, for example, 0.02 to 0.20, 0.02 to 0.18, 0.02 to 0.16, 0.02 to 0.15, 0.03 to 0.20, 0.03 to 0.18, 0.03 to 0.16, 0.03 to 0.15, 0.04 to 0.20, 0.04 to 0.19, 0.04 to 0.15, 0.04 to 0.12, 0.05 to 0.19, or 0.05 to 0.15. Because a is always greater than 0, the sum of the amount of Ni and metal, M, is such that there is excess Ni+M relative to the number of nickel ion sites in the NiO₂ layers and there are alkali metal sites in the crystal lattice which do not include alkali metal ions. The alkali metal sites in the crystal lattice that do not include alkali metal ions can be vacant or occupied by excess Ni (e.g., Ni²⁺) ions or M ions, thereby providing a non-stoichiometric amount of nickel and metal, M, based on the amount of alkali metal, relative to the stoichiometric counterpart having a general formula ANi_{1-z}M_{z}O₂, wherein A is an alkali metal, M comprises an alkaline earth metal, a transition metal, or main group metal, and 0.025≤z≤0.5, for example, 0.025≤z≤0.30 or 0.025≤z≤0.20.

In general, the non-stoichiometric layered alkali nickel-metal composite oxide is essentially non-hydrated; however, there may be excess alkali metal oxide and/or hydroxide from the synthesis of the non-stoichiometric layered alkali nickel-metal composite oxide present on the surface of the non-stoichiometric alkali nickel-metal composite oxide particles which can absorb water from ambient air. Any excess alkali metal oxide or hydroxide also can react with carbon dioxide in ambient air to form alkali metal carbonate on the surface of the alkali nickel-metal composite oxide particles.

The non-stoichiometric layered alkali nickel-metal composite oxide can be demetallated to provide a non-stoichiometric layered alkali-metal deficient layered nickel-metal composite oxide electrochemically active cathode material that can have a general formula AₓH_{y}Ni_{1+a-z}M_{z}O₂·nH₂O, wherein A comprises an alkali metal; M comprises an alkaline earth metal, a transition metal, or a main group metal, 0.02≤x<0.2; 0≤y<0.3; 0.02≤a≤0.2; 0.025≤z≤0.5, and 0<n<2. The non-stoichiometric layered alkali metal-deficient layered nickel-metal composite oxide is also referred to herein as “alpha-demetallated nickel-metal composite oxide,” “alpha-demetallated layered nickel-metal composite oxide,” or “non-stoichiometric demetallated layered nickel-metal composite oxide.” The average oxidation state of the nickel in the alpha-demetallated nickel-metal composite oxide is generally between 3+ and 4+ as the alpha-demetallated nickel-metal composite oxide will include a significant portion of nickel in the 4+ oxidation state as well as some nickel in the 3+ oxidation state. As described below, the alpha-demetallated nickel-metal composite oxide also includes a portion of nickel in the 2+ or 3+ oxidation state located in alkali sites of the crystal lattice. It will be understood that the A in the formula for the alpha-demetallated nickel-metal composite oxide electrochemically active cathode material will be the same as the A in the formula for the non-stoichiometric layered alkali nickel-metal composite oxide material used to prepare the alpha-demetallated nickel-metal composite oxide material. Thus, A can be selected from the group consisting of lithium, sodium, potassium, and a combination thereof. In embodiments, A is lithium.

In embodiments, the alpha-demetallated nickel-metal composite oxide can have a value of x in a range of 0.02≤x<0.2, for example, 0.02 to 0.20, 0.04 to 0.20, 0.06 to 0.20, 0.08 to 0.20, 0.08 to 0.18, 0.08 to 0.16, 0.08 to 0.15, 0.09 to 0.20, 0.09 to 0.19, 0.09 to 0.15, 0.09 to 0.12, 0.10 to 0.19, or 0.10 to 0.15. A value of x for the alpha-demetallated nickel-metal composite oxide below about 0.02 can be the result of one or more of an excess amount of the oxidant provided during oxidative demetallation, too high of a reaction temperature during oxidative demetallation, and/or too long reaction time for oxidative demetallation, and thus it is desirable to control these parameters. A value of x for the alpha-demetallated nickel-metal composite oxide above about 0.2 can be the result of one or more of an insufficient amount of oxidant provided during the oxidative demetallation, too low of a reaction temperature for oxidative demetallation, and/or too short reaction time for oxidative demetallation, further demonstrating that it is desirable to control these parameters. Without intending to be bound by theory, it is believed that as the amount, x, of alkali metal, A, in the alpha-demetallated nickel-metal composite oxide decreases below about 0.08, for example, 0.06, 0.04, 0.02, or less, the alpha-demetallated nickel-metal composite oxide is disadvantageously more likely to form gamma-nickel oxyhydroxide or a gamma-nickel oxyhydroxide isomorph when treated with an aqueous solution of an alkali hydroxide rather than the desirable stabilized form of the non-stoichiometric alkali metal-deficient nickel-metal composite oxide (which has an additional alkali metal ion inserted into vacant sites in the interlayer regions thereof and has the formula AₓA′ᵥNi_{1+a-z}M_{z}O₂·nH₂O, wherein A includes Li or Na; A′ includes Na, K, Rb, or Cs; 0.08≤x<0.2; 0.03<v<0.20; 0.02<a≤0.2; 0.025≤z≤0.5, and 0<n<2, as described in detail below). Further, without intending to be bound by theory, it is believed that as the amount, x, of alkali metal, A, of the alpha-demetallated nickel-metal composite oxide increases above about 0.2, the capacity of the prepared alpha-demetallated nickel-metal composite oxide (as well as the stabilized nickel oxide prepared therefrom) decreases as a result of the presence of unoxidized Ni(III) (i.e., unconverted alkali nickel-metal composite oxide starting material).

In embodiments, the alpha-demetallated nickel-metal composite oxide can have a value of y in a range of 0≤y<0.3, for example, 0 to 0.29, 0.05 to 0.29, 0.05 to 0.25, 0.5 to 0.20, 0.5 to 0.15, 0.08 to 0.29, 0.08 to 0.25, 0.08 to 0.20, 0.08 to 0.15, 0.10 to 0.29, 0.10 to 0.25, 0.10 to 0.20, or 0.10 to 0.15. H⁺ can be introduced into the crystal structure during oxidative demetallation via ion-exchange with the alkali metal cation. In particular, when oxidative demetallation is performed in an aqueous solution, under some conditions water can react with the oxidant to form H⁺ ions which can subsequently partially ion exchange with the alkali metal cations, especially at high temperatures.

In embodiments, the alpha-demetallated nickel-metal composite oxide can have a value of a in a range of 0.02≤a≤0.2, for example, 0.02 to 0.20, 0.02 to 0.18, 0.02 to 0.16, 0.02 to 0.15, 0.03 to 0.20, 0.03 to 0.18, 0.03 to 0.16, 0.03 to 0.15, 0.04 to 0.20, 0.04 to 0.18, 0.04 to 0.15, 0.04 to 0.12, 0.05 to 0.19, or 0.05 to 0.15. Because a must be greater than 0, there are alkali metal sites in the crystal lattice which do not include an alkali metal ion but, instead, are occupied by Ni²⁺, Ni³⁺, or other metal (M) ions thereby providing an excess, non-stoichiometric amount of nickel and/or M. It will be appreciated by one of ordinary skill in the art that some alkali metal sites in the crystal lattice can be vacant and, further, that charge neutrality of the structure will be maintained by substitution of one Ni²⁺ (or M²⁺) ion for 2 Li⁺ ions, or one Ni³⁺ (or M³⁺) ion for 3 Li⁺ ions (or one Ni²⁺/M²⁺ ion and one Li⁺ ion), for example.

It will be understood that the M in the formula for the alpha-demetallated nickel-metal composite oxide electrochemically active cathode material will be the same as the M in the formula for the non-stoichiometric alkali nickel-metal composite oxide material used to prepare the alpha-demetallated nickel-metal composite oxide material. In embodiments, M can be one or more second metals selected from manganese, aluminum, magnesium, titanium, vanadium, chromium, copper, zinc, iron, and cobalt. In some embodiments, M comprises manganese, magnesium, aluminum, iron, or a combination thereof. In some embodiments, M comprises manganese, magnesium, iron, or a combination thereof. In some embodiments, M comprises manganese. In some embodiments, M comprises iron. The manganese, magnesium, aluminum, and iron can be present as Mn⁺⁴, Mg⁺³, Al⁺³, or Fe⁺³, respectively.

In embodiments, z can have a value of 0.025≤z≤0.5, for example about 0.025 to about 0.5, about 0.025 to about 0.30, about 0.025 to about 0.25, about 0.025 to about 0.20, about 0.025 to about 0.125, about 0.05 to about 0.5, about 0.075 to about 0.4, about 0.075 to about 0.35, about 0.08 to about 0.30, about 0.09 to about 0.30, about 0.05 to about 0.25, about 0.08 to about 0.25, about 0.1 to about 0.25, or about 0.08 to about 0.125. Without intending to be bound by theory, it is believed that as the amount of metal, M, in the alpha-demetallated nickel-metal composite oxide increases, the stability of an electrochemically active material including the alpha-demetallated nickel-metal composite oxide to an aqueous alkali metal hydroxide solution, such as an alkaline battery electrolyte, increases but the total discharge capacity can decrease. Further, without intending to be bound by theory, it is believed that if the amount of metal, M, increases above about 50% (i.e., z>0.5) the layered structure of the material collapses, resulting in a significant decrease in the electrochemical activity of the material.

The alpha-demetallated layered nickel-metal composite oxide also is characterized by a layered lattice structure that is generally isomorphic with lithium nickel oxide or sodium nickel oxide. The alpha-demetallated layered nickel-metal composite oxide, like the non-stoichiometric alkali nickel-metal composite oxide, has a lattice structure made up of a plurality of NiO₂-type layers that are isomorphic with ideal NiO₂ layers but can comprise NiO₆ and MO₆ octahedra building blocks that share edges with other NiO₆ or MO₆ octahedron, such that a portion of the nickel ion sites in an ideal NiO₂ layers can be occupied by an additional second metal, M. The alkali ions of the alpha-demetallated layered nickel-metal composite oxide are located in octahedral and/or tetrahedral sites defined by the oxygen atoms, in an interlayer region between NiO₂-type layers. In addition to, or in the alternative to, the additional second metal, M, occupying some of the nickel ion sites, the metal, M, can occupy some of the alkali sites of the layered lattice structure. For example, M can be present in an amount in a range of about 2.5 mol. % to less than 50 mol. %, relative to the total non-alkali metal content, for example, about 5 mol. % to about 40 mol. %, about 10 mol. % to about 30 mol. %, or about 15 mol. % to about 25 mol. %, about 14 mol. % to about 22 mol. %, about 5% to about 20%, about 5 mol. % to about 16 mol. %, or about 30 mol. % to about 40 mol. % M can be present in an amount in a range of about 2.5 mol. % to about 25 mol. %, relative to the total non-alkali metal content. M can be present in an amount in a range of about 2.5 mol % to about 20 mol %, relative to the total non-alkali metal content. The alpha-demetallated layered nickel-metal composite oxide structure differs from that of the non-stoichiometric alkali nickel-metal composite oxide in that it contains fewer alkali ions, A, in the interlayer region than the non-stoichiometric alkali nickel-metal composite oxide.

In some embodiments, the electrochemically active cathode material of the disclosure can have a formula LiₓH_{y}Ni_{1+a-z}M_{z}O₂, wherein: 0.02≤x≤0.2; 0≤y<0.3; 0.02≤a≤0.2; 0.05≤z≤0.5; and M is chosen from one or more in the group of manganese ion, aluminum ion, and iron ion. In some embodiments, the electrochemically active cathode material of the disclosure can have a formula LiₓH_{y}Ni_{1+a-z}M_{z}O₂, wherein: 0.02≤x≤0.2; 0≤y<0.3; 0.02≤a≤0.2; 0.05≤z≤0.5; and M is chosen from one or more in the group of manganese ion, and iron ion. In some embodiments, the electrochemically active cathode material of the disclosure can have a formula LiₓH_{y}Ni_{1+a-z}M_{z}O₂, wherein: 0.02≤x≤0.2; 0≤y<0.3; 0.02≤a≤0.2; 0.05≤z≤0.25; and M is chosen from one or more in the group of manganese ion and iron ion. In some embodiments, the electrochemically active cathode material of the disclosure can have a formula LiₓH_{y}Ni_{1+a-z}M_{z}O₂, wherein: 0.02≤x≤0.2; 0≤y<0.3; 0.02≤a≤0.2; 0.05≤z≤0.2; and M is chosen from one or more in the group of manganese ion and iron ion. In some embodiments, the electrochemically active cathode material of the disclosure can have a formula LiₓH_{y}Ni_{1+a-z}Mn_{z}O₂, wherein: 0.02≤x≤0.2; 0≤y<0.3; 0.02≤a≤0.2; and 0.05≤z≤0.5. In some embodiments, the electrochemically active cathode material of the disclosure can have a formula LiₓH_{y}Ni_{1+a-z}M_{z}O₂, wherein: 0.02≤x≤0.2; 0≤y<0.3; 0.02≤a≤0.2; and 0.2≤z≤0.5; and M is chosen from one or more in the group of manganese ion, aluminum ion, and iron ion. In some embodiments, the electrochemically active cathode material of the disclosure can have a formula LiₓH_{y}Ni_{1+a-z}Mn_{z}O₂, wherein: 0.02≤x≤0.2; 0≤y<0.3; 0.02≤a≤0.2; and 0.2≤z≤0.5.

The stabilized non-stoichiometric alkali-metal deficient layered nickel-metal composite oxide is prepared from the alpha-demetallated nickel-metal composite oxide and can have a general formula AₓA′ᵥNi_{1+a-z}M_{z}O₂·nH₂O, wherein A includes any A disclosed herein for the non-stoichiometric alkali nickel-metal composite oxide or the alpha-demetallated nickel-metal composite oxide; M includes any M disclosed herein for the non-stoichiometric alkali nickel-metal composite oxide or the alpha-demetallated nickel-metal composite oxide; A′ includes K, Rb, or Cs; 0.02≤x<0.2; 0.03<v<0.20; 0.02<a≤0.2; 0.025≤z≤0.5, and 0<n<2. The stabilized non-stoichiometric alkali-metal deficient layered nickel-metal composite oxide is also referred to herein as “beta-demetallated layered nickel-metal composite oxide,” “stabilized non-stoichiometric demetallated layered nickel-metal composite oxide,” or “beta-demetallated nickel-metal composite oxide.” The beta-demetallated layered nickel-metal composite oxide is characterized by a layered lattice structure that is generally isomorphic with lithium nickel oxide or sodium nickel oxide. The beta-demetallated layered nickel-metal composite oxide has a lattice structure made up of a plurality of NiO₂-type layers that are isomorphic with ideal NiO₂ layers but can comprise NiO₆ and MO₆ octahedra building blocks that share edges with other NiO₆ or MO₆ octahedron, such that a portion of the nickel ion sites in an ideal NiO₂ layers can be occupied by an additional second metal, M. As with the corresponding alpha structure described above, the alkali ions of the beta-demetallated layered nickel-metal composite oxide are located in octahedral and/or tetrahedral sites defined by the oxygen atoms, in an interlayer region between NiO₂-type layers. In addition to, or in the alternative to, the additional second metal, M, occupying some of the nickel ion sites, the metal, M, can occupy some of the alkali sites of the layered lattice structure. The beta-demetallated layered nickel-metal composite oxide structure differs from that of the alpha-demetallated layered nickel-metal composite oxide in that the beta-demetallated layered nickel-metal composite oxide contains additional alkali ions, A′, in the interlayer region that are not present in the alpha-demetallated layered nickel-metal composite oxide.

It will be understood that the A in the formula for the beta-demetallated layered nickel-metal composite oxide electrochemically active cathode material will be the same as the A in the formula for the alpha-demetallated nickel-metal composite oxide material used to prepare the beta-demetallated nickel-metal composite oxide material. In general, A can be Li or Na. In embodiments, A comprises Li. In general, A′ can be K, Rb or Cs, and A′ and A are different. In embodiments, A′ comprises K. In embodiments, A′ comprises Rb or Cs, or a combination thereof. In embodiments, A comprises Li and A′ comprises K. In embodiments, x can be in a range of 0.02 to 0.2, for example, 0.04 to 0.2, 0.06 to 0.2, 0.08 to 0.2, 0.08 to 0.18, 0.08 to 0.16, 0.08 to 0.15, 0.09 to 0.20, 0.09 to 0.19, 0.09 to 0.15, 0.09 to 0.12, 0.10 to 0.19, or 0.10 to 0.15. In embodiments, v can be in a range of 0.03 to 0.20, for example, 0.03 to 0.17, 0.03 to 0.15, 0.03 to 0.13, 0.06 to 0.20, 0.06 to 0.17, 0.06 to 0.15, 0.06 to 0.13, 0.08 to 0.17, 0.08 to 0.15, or 0.08 to 0.13. In embodiments, a can be in a range of 0.02≤a≤0.20, for example 0.02 to 0.18, 0.02 to 0.16, 0.03 to 0.20, 0.03 to 0.17, 0.03 to 0.15, 0.04 to 0.20, 0.04 to 0.17, 0.04 to 0.15, 0.04 to 0.13, or 0.04 to 0.11. In embodiments, n can be in a range of 0<n<2, for example, about 0.01 to about 1.9, about 0.02 to about 1.8, about 0.05 to about 1.8, about 0.05 to about 1.5, about 0.05 to about 1.25, about 0.05 to about 1.0, about 0.1 to about 1.8, about 0.1 to about 1.5, about 0.1 to about 1.25, about 0.1 to about 1.0, about 0.15 to about 1.8, about 0.15 to about 1.5, about 0.15 to about 1.25, about 0.15 to about 1, about 0.15 to about 0.8, about 0.15 to about 0.75, about 0.15 to about 0.7, or about 0.15 to about 0.6. It will be understood that the M in the formula for the beta-demetallated nickel-metal composite oxide electrochemically active cathode material will be the same as the M in the formula for the alpha-demetallated nickel-metal composite oxide material used to prepare the beta-demetallated nickel-metal composite oxide material. In embodiments, z can have a value in a range of 0.025≤z≤0.5, for example about 0.025 to about 0.5, about 0.025 to about 0.30, about 0.025 to about 0.25, about 0.025 to about 0.20, about 0.025 to about 0.125, about 0.05 to about 0.5, about 0.075 to about 0.4, about 0.075 to about 0.35, about 0.08 to about 0.30, about 0.09 to about 0.30, about 0.05 to about 0.25, about 0.05 to about 0.20, about 0.08 to about 0.25, 0.08 to about 0.20, about 0.1 to about 0.25, about 0.08 to about 0.15, or about 0.08 to about 0.125.

Without intending to be bound by theory, it is believed that as the amount of metal, M, in the beta-demetallated nickel-metal composite oxide increases, the stability of an electrochemically active material including the beta-demetallated nickel-metal composite oxide to an aqueous alkali metal hydroxide solution, such as an alkaline battery electrolyte, increases but the total discharge capacity can decrease. It was unexpectedly found that the decrease in total discharge capacity was not as significant as would be expected when nickel is replaced by the transition or main group metal, M. As shown in the examples herein, when the second metal ion M comprises manganese and the manganese was provided in an amount in a range of 5 mol % to 16 mol % (relative to the total amount of transition metal, i.e., the combined amount of both nickel and manganese), the resulting material demonstrated substantially the same discharge capacity as the identical material where manganese had not been substituted for nickel (e.g., the resulting material had about 89% to 92% of the discharge capacity of the control comprising only nickel atoms (i.e., in which there is no substitution of nickel ions with second non-alkali metal ions). Such a result is surprising in view of the expectation that manganese is less electrochemically active than nickel.

Gassing properties of the beta-demetallated nickel-metal composite oxides of the disclosure as determined by the Oxygen Evolution test disclosed herein are indicative of the stability of the electrochemically active cathode material over time when provided in a battery. In general, if the electrochemically active cathode material is more reactive with electrolyte, the amount of gas evolved increases. Without intending to be bound by theory, it is believed that as the stability of an electrochemically active cathode material increases, as determined by the decreased gas generation in the Oxygen Evolution test, the shelf life of a battery including the electrochemically active cathode material, and particularly the high rate performance over time of said battery, increases.

Further, without intending to be bound by theory, it is believed that as the amount of metal, M, in the beta-demetallated nickel-metal composite oxide increases, the volumetric energy density of the resulting material can decrease, for example, because the second metal ion M is typically less electroactive than nickel. It was unexpectedly found that the volumetric energy density did not decrease as significantly as would be expected when nickel is replaced by the transition or main group metal, M. As shown in the examples herein, when M comprises manganese, the resulting material demonstrated substantially the same volumetric energy as the identical material where manganese had not been substituted for nickel density (e.g., about 87% to 96% of the volumetric energy density of the control beta-demetallated layered nickel oxide compound comprising only nickel atoms in which there is no substitution of nickel ions with manganese ions or other non-alkali metal ions).

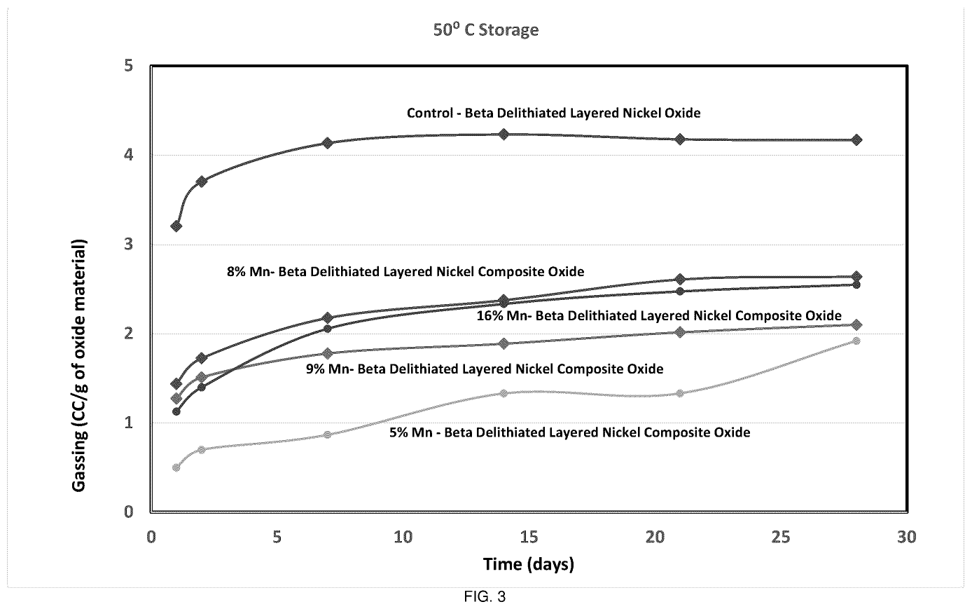

As demonstrated in the examples herein, the beta-demetallated layered nickel-metal composite oxides of the disclosure advantageously demonstrated reduced gassing (i.e., increased stability) when tested according to the Oxygen Evolution Test disclosed herein at 50° C., relative to a control beta-demetallated layered nickel oxide material without an additional second metal, M, (FIG. 3), while a battery including the beta-demetallated layered nickel-metal composite oxides of the disclosure as the electrochemically active cathode material advantageously demonstrated substantially the same discharge capacity relative to a battery including the control beta-demetallated layered nickel oxide material without the additional second metal ion, M, and improved discharge capacity relative to a battery including electrolytic manganese dioxide as the electrochemically active cathode material (FIG. 4A). Further advantageously, as shown in FIG. 4C, the beta-demetallated layered nickel-metal composite oxides of the disclosure delivered significantly more capacity than the control beta-demetallated layered nickel-metal oxide without the additional second metal, M, in a voltage window between 1.4 V and 1.65 V. The demonstrated capacity in the voltage window between 1.4 V and 1.65 V for a beta-demetallated layered nickel-metal composite oxide of the disclosure as shown in FIGS. 4A and 4C, was particularly unexpected in view of the substitution of Mn for Ni(IV). Increasing capacity delivery at higher voltage can be particularly advantageous for high power applications.

The beta-demetallated layered nickel-metal composite oxides of the disclosure can show relatively less reactivity, as demonstrated by generating less than about 3 cc of oxygen per gram of beta-demetallated layered nickel-metal composite oxide over at least 28 days as determined in accordance with the Oxygen Evolution Test at 50° C., disclosed herein. The beta-demetallated layered nickel-metal composite oxides of the disclosure can generate about 1 cc/g to about 3 cc/g over 28 days as determined in accordance with the Oxygen Evolution Test at 50° C., disclosed herein.

The beta-demetallated layered nickel-metal composite oxides of the disclosure can provide a gravimetric capacity greater than about 300 mAh/g, greater than about 310 mAh/g, or greater than about 320 mAh/g, and/or up to about 400 mAh/g, up to about 380 mAh/g, or up to about 360 mAh/g, when provided as the sole electrochemically active material in a 635 button cell and tested in accordance with the Low Rate Discharge Capacity Test disclosed herein. The beta-demetallated layered nickel-metal composite oxides of the disclosure can provide a gravimetric capacity greater than about 200 mAh/g, about 225 mAh/g, or about 235 mAh/g, and/or up to about 300 mAh/g, about 280 mAh/g, or about 260 mAh/g at voltages between 1.4 V and 1.65 V, when provided as the sole electrochemically active material in a 635 button cell and tested in accordance with the Low Rate Discharge Capacity Test disclosed herein. The beta-demetallated layered nickel-metal composite oxides of the disclosure can provide a volumetric energy density of at least 1900 Wh/L, when provided as the sole electrochemically active material in a 635 button cell and tested in accordance with the Low Rate Discharge Capacity Test disclosed herein.

The beta-demetallated layered nickel-metal composite oxides may have a characteristic powder X-ray diffraction pattern. Powder X-ray diffraction (pXRD) is an analytical technique that is used to characterize the crystal lattice structure of a sample material, such as a crystalline powder. XRD analysis of a crystalline sample material will result in a characteristic diffraction pattern consisting of peaks of varying intensities, widths, and diffraction angles (peak positions) corresponding to diffraction planes in the crystal structure of the sample material. XRD patterns can be measured with an X-ray diffractometer using Cu Kα or Cr Kα radiation by standard methods as is described, for example, by B. D. Cullity and S. R. Stock, Elements of X-ray Diffraction (3^{rd} ed. 2001). A D-8 Advance X-ray diffractometer, available from Bruker Corporation (Madison, WI, USA), Rigaku Miniflex diffractometer, available from Rigaku Corporation (Auburn Hills, MI, USA), or equivalent, may be used to complete powder XRD analysis on a sample material, such as a non-stoichiometric beta-delithiated layered nickel-metal composite oxide. The unit cell parameters, such as unit cell lengths and angles, of the sample material can be determined, for example, by Rietveld refinement of the XRD pattern. Rietveld refinement is described, for example, by H. M. Rietveld, “A Profile Refinement Method for Nuclear and Magnetic Structures”, Journal of Applied Crystallography, pp. 65-71 (1969).

The crystallite size of the sample material can be determined by peak broadening of the XRD pattern of a sample material that contains a silicon (Si) standard. Peak broadening analysis may be completed, for example, by the single-peak Scherrer method or the Warren-Averbach method as is discussed, for example, by H. P. Klug and L. E. Alexander, “X-ray Diffraction Procedures for Polycrystalline and Amorphous Materials”, Wiley, pp. 618-694 (1974). The Warren-Averbach method may also be used to determine the residual strain and stress of the sample material.

The full width at half maximum (FWHM) can be used to characterize the relative sharpness, or broadness, of the lines in the diffraction pattern of the sample material. The FWHM can be determined by measuring the intensity of a peak; dividing the measured intensity by two to calculate half intensity (half height); and measuring the width of the peak at the calculated half height.

The normalized intensity can be used, along with peak position, to compare the relative efficiency of diffraction associated with the particular diffraction planes within the crystal lattice of the sample material. The normalized intensity may be calculated for peaks within the same XRD pattern. All peaks of the XRD pattern may be normalized to the peak having the highest intensity (the reference peak). Normalization, which is reported in percent, occurs by dividing the intensity of the peak expressed in counts being normalized by the intensity of the reference peak expressed in counts and multiplying by 100. For example, the reference peak may have an intensity of 425 and the peak being normalized may have an intensity of 106. The normalized intensity of the peak is 25%, e.g., [(106/425)·100]. The reference peak will have a normalized intensity of 100%.

The resulting XRD pattern may be compared with known XRD patterns. The comparative XRD patterns may be generated from known sample materials. In addition, the resulting XRD pattern may be compared with known XRD patterns within, for example, the Powder Diffraction File (PDF) database, available from International Centre for Diffraction Data (Newton Square, PA, USA), or the Inorganic Crystal Structure Database (ICSD), available from FIZ Karlsruhe (Eggenstein-Leopoldshafen, Germany). The comparison to known sample materials or the PDF (International center for Diffraction Data, Newton Square, PA) determines if the resulting XRD pattern of the sample material is distinct, similar, or equivalent to known XRD patterns of materials. Known XRD patterns within the PDF database for comparison to, for example, the disclosed beta-delithiated layered nickel-metal composite oxide include PDF #00-06-0141 for beta-nickel oxyhydroxide; PDF #00-00675 for gamma-nickel oxyhydroxide; PDF #00-006-0075 for nickel oxide; and PDF #00-059-0463 for beta-nickel hydroxide.

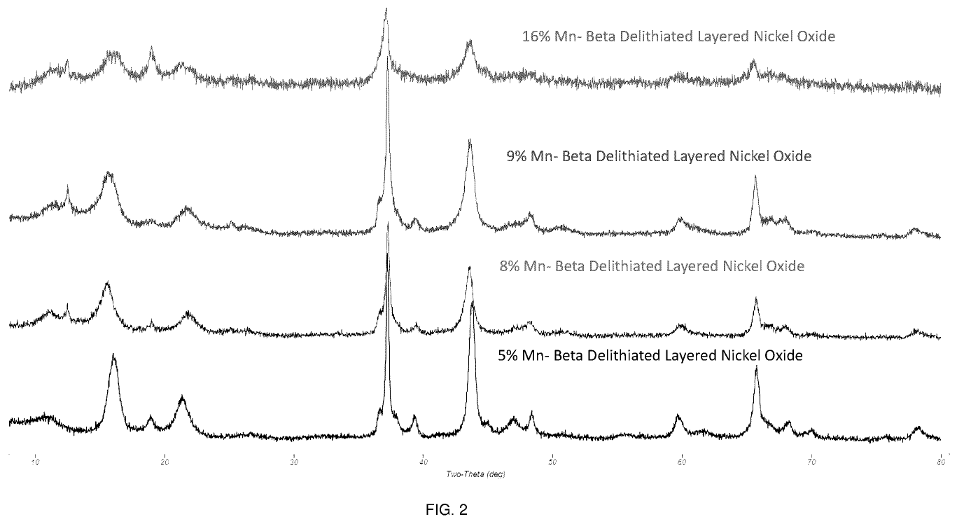

An example of an XRD pattern for a beta-delithiated layered nickel-manganese composite oxide according to the disclosure is depicted in FIG. 2. Unexpectedly, the measured XRD pattern for the non-stoichiometric beta-delithiated layered nickel-manganese composite oxide substantially corresponds to the X-ray diffraction pattern reported for a beta-delithiated layered nickel oxide having a general formula LiₓK_{y}Ni₁₊ₐO₂·nH₂O, wherein 0.02≤x≤0.20; 0.03≤y≤0.20; 0.02≤a≤0.20; and 0<n<2, as generally disclosed in U.S. Pat. No. 10,910,647, which is hereby incorporated herein by reference. Without intending to be bound by theory, it is believed that the presence of the metal ions does not disrupt the long-range ordering of the NiO₂ layered structure. The XRD pattern of the beta-delithiated layered nickel-metal composite oxides disclosed herein may include several peaks, or combination of peaks, that are similarly found in a beta-delithiated layered nickel oxide as disclosed in U.S. Pat. No. 10,910,647, which again is hereby incorporated by reference, which presence corroborates formation of a beta-delithiated layered nickel-metal composite oxide as disclosed herein. The XRD pattern may include characteristic FWHM values similarly found in a beta-delithiated layered nickel oxide for the several peaks of the beta-delithiated layered nickel-metal composite oxide. The XRD pattern may also include characteristic normalized intensities similarly found in a beta-delithiated layered nickel oxide for the several peaks of the beta-delithiated layered nickel-metal composite oxide. The XRD pattern of the beta-delithiated layered nickel-metal composite oxide may include a first peak. The first peak may have a peak position on the XRD pattern of from about 14.9°2θ to about 16.0°2θ. The first peak may be, for example, at about 15.4°2θ. The XRD pattern of the beta-delithiated layered nickel-metal composite oxide may include a second peak. The second peak may have a peak position on the XRD pattern of from about 21.3°2θ to about 22.7°2θ. The second peak may be, for example, at about 22.1°2θ. The XRD pattern of the beta-delithiated layered nickel-metal composite oxide may include a third peak. The third peak may have a peak position on the XRD pattern of from about 37.1°2θ to about 37.4°2θ. The third peak may be, for example, at about 37.3°2θ. The XRD pattern of the beta-delithiated layered nickel-metal composite oxide may include a fourth peak. The fourth peak may have a peak position on the XRD pattern of from about 43.2°2θ to about 44.0°2θ. The fourth peak may be, for example, at about 43.6°2θ. The XRD pattern of the beta-delithiated layered nickel-metal composite oxide may include a fifth peak. The fifth peak may have a peak position on the XRD pattern of from about 59.6°2θ to about 60.6°2θ. The fifth peak may be, for example, at about 60.1°2θ. The XRD pattern of the beta-delithiated layered nickel-metal composite oxide may include a sixth peak. The sixth peak may have a peak position on the XRD pattern of from about 65.4°2θ to about 65.9°2θ. The sixth peak may be, for example, at about 65.7°2θ.

The electrochemically active cathode materials of the disclosure can comprise a beta-delithiated layered nickel-metal composite oxide having a layered crystal structure, the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to less than about 50 mol % of the second metal ion relative to the total non-alkali metal content, and wherein the electrochemically active cathode material has a gravimetric capacity greater than about 300 mAh/g, greater than about 310 mAh/g, and/or greater than about 320 mAh/g, when an alkaline 635 button cell including the beta-delithiated layered nickel-metal composite oxide electrochemically active cathode material as the sole electrochemically active cathode material is discharged at a low discharge rate (e.g., <C/30 or <C/40) to a cutoff of 0.60 V. For example, the electrochemically active cathode material includes about 2.5 mol % to about 50 mol %, for example, about 5 mol % to about 40 mol %, about 5 mol % to about 30 mol %, about 10 mol % to about 30 mol %, or about 15 mol % to about 25 mol %, about 14 mol % to about 22 mol %, about 5 mol % to about 20 mol %, about 5 mol % to about 16 mol %, or about 30 mol % to about 40 mol % of additional second metal, M relative to the total non-alkali metal content. Consistent with a reduction in reactivity, the electrochemically active cathode material can generate less than 3 cc of oxygen per g of electrochemically active cathode material over at least 28 days as determined in accordance with the Oxygen Evolution Test at 50° C., disclosed herein. The electrochemically active cathode material can have a gravimetric capacity greater than about 200 mAh/g, greater than about 225 mAh/g, or greater than about 235 mAh/g, at voltages between 1.4 V and 1.65 V, when an alkaline 635 button cell including the beta-demetallated layered nickel-metal composite oxide electrochemically active cathode material as the sole electrochemically active cathode material is discharged at a low discharge rate (e.g., <C/30 or <C/40) to a cutoff of 1.40V.

The electrochemically active cathode material of the disclosure can generally have any suitable particle size. In embodiments, the electrochemically active cathode material of the disclosure can have a D50 mean particle size of 8.0 microns or less, for example, in a range of about 2.0 microns to about 8.0 microns, for example, about 3.0 microns to about 7.0 microns, about 4.0 microns to about 6.0 microns, or about 4.4 microns to about 5.4 microns. The mean particle size and size distribution can be determined with a laser diffraction particle size analyzer (e.g., a SympaTec Helos particle size analyzer equipped with a Rodos dry powder dispersing unit) using algorithms based on Fraunhofer or Mie theory to compute the volume distribution of particle sizes and mean particle sizes. Particle size distribution and volume distribution calculations are described, for example, in M. Puckhaber and S. Rothele (Powder Handling & Processing, 1999, U11(1), 91-95 and European Cement Magazine, 2000, 18-21). Without intending to be bound by theory, it is believed that as the particle size decreases, for example, below about 2.0 microns the stability of the electrochemically active material is expected to decrease due to increased surface area available to react with alkaline electrolyte. Further, without intending to be bound by theory, it is believed that as the particle size increases, for example, above about 8.0 microns, the capacity of the electrochemically active material is expected to decrease due to increased amounts of defects in the crystal structure that can negatively affect capacity. Without intending to be bound by theory, it is believed that particles having a D50 particles size in a range of about 2.0 microns to about 8.0 microns have suitable diffusion properties allowing for better electrochemical activity and rate capability, without being so small that they are overly reactive with the electrolyte solution or so large that defects in the crystal structure affect the capacity of the material.

The content of the alkali metal(s), alkaline earth metal(s), transition metal(s), and/or non-transition metal(s) within the electrochemically active cathode materials of the disclosure may be determined by any acceptable method known in the art. For example, the content of the alkali metal(s) and transition metal(s) within the compounds may be determined by inductively coupled plasma atomic emission spectroscopy (ICP-AES) and/or atomic absorption (AA) spectroscopy. ICP-AES and/or AA analyses may be completed, for example, using standard methods as described, for example, by J. R. Dean, Practical Inductively Coupled Plasma Spectroscopy, pp. 65-87 (2005) and B. Welz and M. B. Sperling, Atomic Absorption Spectrometry, pp. 221-294 (3rd ed. 1999). An Ultima 2 ICP spectrometer, available from HORIBA Scientific (Kyoto, Japan), may be used to complete ICP-AES analysis on a sample material, such as a non-stoichiometric beta-demetallated layered nickel-metal composite oxide. ICP-AES analysis of the non-stoichiometric beta-demetallated layered nickel-metal composite oxide can be performed at varying wavelengths depending upon the elements contained within the non-stoichiometric beta-demetallated layered nickel-metal composite oxide.

True densities of the electrochemically active cathode material of the disclosure can be measured by a He gas pycnometer (e.g., Quantachrome Utrapyc Model 1200e) as described in general by P. A. Webb (“Volume and Density Determinations for Particle Technologists,” Internal Report, Micromeritics Instrument Corp., 2001, pp. 8-9) and in, for example, ASTM Standard D5965-02 (“Standard Test Methods for Specific Gravity of Coating Powders,” ASTM International, West Conshohocken, PA, 2007) and ASTM Standard B923-02 (“Standard Test Method for Metal Powder Skeletal Density by Helium or Nitrogen Pycnometry,” ASTM International, West Conshohocken, PA, 2008). True density is defined, for example, by the British Standards Institute, as the mass of a particle divided by its volume, excluding open and closed pores.

### Methods of Preparing an Electrochemically Active Cathode Material.

### Preparation of Nickel-Metal Composite Precursors

The compounds of the disclosure can generally be prepared in multiple steps from a Ni(II)-metal composite precursor compound. In embodiments, the precursor compound can be a nickel metal carbonate such as nickel manganese carbonate, a nickel metal hydroxide such as nickel manganese hydroxide, a nickel metal nitrate, a nickel metal acetate, a nickel metal citrate, or a combination thereof. In embodiments, the nickel metal carbonate can have a formula Ni_{1-z}M_{z}CO₃, wherein z has any suitable value for z disclosed herein. The precursor materials are generally formed by a precipitation reaction and are not made in the solid state. As used herein, a “solid state” reaction refers to mechanical blending that can include heat and pressure, but are free of solvents.

An exemplary nickel metal carbonate starting material, nickel manganese carbonate, can be prepared as described herein. Aluminum, magnesium, titanium, vanadium, chromium, copper, zinc, iron, and cobalt may be incorporated in a similar manner to the method described for nickel manganese carbonate. Nickel manganese carbonate can be prepared from a precipitation reaction between nickel manganese sulfate and a carbonate source, optionally in the presence of a chelating agent. The nickel manganese sulfate can have a formula Ni_{1-z}Mn_{z}SO₄, wherein z has any suitable value for z disclosed herein. In embodiments, the carbonate source can include sodium carbonate.

The nickel manganese sulfate can be admixed in solution with the carbonate source. Alternatively, nickel sulfate solution and manganese sulfate solution can be admixed with the carbonate source. The nickel sulfate, manganese sulfate, and carbonate source can be provided in a molar ratio of about 1:1:1. The solvent for the solution can be any solvent for the nickel manganese sulfate (or nickel sulfate and manganese sulfate), the carbonate source, or both, for example, water. In some embodiments, the concentration of nickel manganese sulfate, nickel sulfate, and/or manganese sulfate in the solution can be in a range of about 0.5M to about 4M, about 1M to about 3M, about 1.5M to about 2.5M, or about 2M. In some embodiments, the concentration of carbonate in the solution can be in a range of about 0.5M to about 4M, about 1M to about 3M, about 1.5M to about 2.5M, or about 2M. In embodiments wherein a chelating agent is present, the chelating agent can be admixed in solution with the nickel, manganese, and carbonate source. After admixing the nickel manganese sulfate (or nickel sulfate and manganese sulfate) and the carbonate source, the resulting mixture can be heated to a suitable temperature for a suitable time to allow precipitation of the nickel manganese carbonate. The temperature of the mixture can be in a range of about 30° C. to about 75° C., about 40° C. to about 75° C., about 50° C. to about 70° C., or about 55° C. to about 65° C. The mixture can be stirred at the elevated temperature for about 1 hour to about 3 hours, about 1.5 hours to about 2.5 hours, or about 2 hours. The resulting nickel manganese carbonate can be isolated from the solution and stored for further use or used directly in the next step.

### Preparation of Non-Stoichiometric Layered Alkali Nickel-Metal Composite Oxide

The non-stoichiometric alkali nickel-metal composite oxide has the general formula A₁₋ₐNi_{1+a-z}M_{z}O₂, wherein a has any suitable value for a disclosed herein and z has any suitable value for z disclosed herein and, specifically, has the same value of z as the carbonate precursor, Ni_{1-z}M_{z}CO₃. The non-stoichiometric alkali nickel-metal composite oxide, can be prepared by heat treating the nickel metal carbonate precursor in the presence of an alkali metal source. The alkali metal source can be an alkali salt. The alkali metal source can include, but is not limited to, alkali hydroxides, alkali carbonates, and alkali nitrates. In embodiments, the alkali metal source can be a lithium salt. The lithium salt can be selected from hydrated lithium hydroxide (LiOH·H₂O), lithium carbonate (Li₂CO₃), lithium nitrate, or a combination thereof. In general, the nickel metal carbonate is admixed with the lithium salt and calcined to form the non-stoichiometric lithium nickel-metal composite oxide, A₁₋ₐNi_{1+a-z}M_{z}O₂. The calcination can take place at any suitable temperature for any suitable time to form the non-stoichiometric alkali nickel-metal composite oxide. For example, the calcination temperature can be in a range of about 500° C. to about 1200° C., about 600° C. to about 1150° C., about 700° C. to about 1100° C., about 800° C. to about 1000° C., about 875° C. to about 975° C., about 900° C. to about 950° C., or about 925° C. The mixture can be calcined for about 8 hours to about 48 hours, about 10 hours to about 34 hours, about 12 hours to about 36 hours, about 18 hours to about 30 hours, about 20 hours to about 28 hours, about 22 hours to about 26 hours, or about 24 hours. Conversion to the non-stoichiometric lithium nickel-metal composite oxide can be determined through XRD analysis and by measuring the average oxidation state of the nickel, according to known methods.

The non-stoichiometric alkali nickel-metal composite oxide having the general formula A₁₋ₐNi_{1+a-z}M_{z}O₂, wherein a has any suitable value for a disclosed herein and z has any suitable value for z disclosed herein can be prepared by admixing a nickel nitrate, a metal nitrate (e.g., a manganese nitrate), and an alkali metal nitrate to form a mixture and annealing the mixture under a flow of oxygen to form the non-stoichiometric alkali nickel-metal composite oxide.

In general, the admixture is annealed to form the non-stoichiometric alkali nickel-metal composite oxide, A₁₋ₐNi_{1+a-z}M_{z}O₂. The annealing can take place at any suitable temperature for any suitable time to form the non-stoichiometric alkali nickel-metal composite oxide. For example, the annealing temperature can be in a range of about 500° C. to about 1200° C., about 600° C. to about 1150° C., about 700° C. to about 1100° C., about 800° C. to about 1000° C., about 800° C. to about 950° C., about 850° C. to about 900° C., or about 875° C. The mixture can be annealed for about 8 hours to about 48 hours, about 10 hours to about 24 hours, about 12 hours to about 18 hours, about 14 hours to about 17 hours, or about 15 hours. Conversion to the non-stoichiometric alkali nickel-metal composite oxide can be determined through XRD analysis and by measuring the average oxidation state of the nickel, according to known methods.

The resulting non-stoichiometric alkali nickel metal composite oxide can stored for further use or used directly in the next step.

### Preparation of Non-Stoichiometric Alkali Metal-Deficient Layered Nickel-Metal Composite Oxide (Alpha-Demetallated Layered Nickel-Metal Composite Oxide)

Alkali metal-containing transition metal oxides can be energetically activated or “charged” for the purpose of preparing highly oxidized cathode materials for use in both primary and secondary electrochemical cells. Charging of the alkali metal-containing transition metal oxides comprises oxidation of the transition metal and removal of the alkali metal from the metal oxide crystal lattice, in part or in whole, to form an alkali metal-deficient transition metal oxide electrochemically active cathode material. The alkali metal-containing transition metal oxides can be chemically charged or electrochemically charged. Methods of chemically charging the alkali metal-containing transition metal oxides can include oxidative demetallation and acid-promoted disproportionation of the transition metal, e.g., by treatment with a mineral acid.

The non-stoichiometric layered alkali nickel metal composite oxide can generally be treated under any conditions sufficient to remove a portion of the alkali metal from the composition and oxidize at least a portion of the nickel from a nickel (III) oxidation state to a nickel (IV) oxidation state to form the non-stoichiometric alkali metal-deficient layered nickel-metal composite oxide having the formula AₓH_{y}Ni_{1+a-z}M_{z}O₂, wherein A, x, a, y, and z are any suitable x, a, y, and z disclosed herein, respectively. The values for a and z need not be the same as in the non-stoichiometric layered alkali nickel metal composite oxide precursor, and may change depending on the oxidation method. For example, nickel (III) disproportionates when treated with a mineral acid, while the M, such as manganese, may not. Thus, the relative amount of M may increase during oxidation with a mineral acid in view of some of the nickel dissolving out of the compound with the amount of M remaining unchanged.

Oxidative demetallation of the non-stoichiometric layered alkali nickel metal composite oxide can comprise treating the non-stoichiometric layered alkali nickel metal composite oxide with a mineral acid and/or a persulfate. The treating with a persulfate can be performed according to the methods disclosed in U.S. Patent Application Publication No. 2021/0234166, which is herein incorporated by reference in the entirety.

It is known that acid-promoted disproportionation of alkali metal-containing transition metal oxides including metals such as Ni results in extraction of essentially all the alkali metal ions present from the crystal lattice as well as oxidation of at most 50% of the metal, for example from an M(III) oxidation state to an M(IV) oxidation state. A corresponding amount of the M(III) is reduced to M(II), which dissolves in the acid solution.

The acid-promoted disproportionation reaction can be summarized, using stoichiometric layered lithium nickel oxide as an example, as follows in Equation 1:

$${LiNiO}_{2} + 2 y {H}_{2} {SO}_{4} \to ( 1 - y ) L {i}_{( 1 - 2 y ) / ( 1 - y )} N i {O}_{2} + y {NiSO}_{4} + y {Li}_{2} S {O}_{4} + 2 y {H}_{2} O ( 0 \leq y \leq 1 / 2 ) \qquad ( 1 )$$

The Ni(II) ions are soluble and dissolve in the aqueous acid solution. Thus, use of an acid-promoted metal disproportionation reaction to chemically charge an alkali metal containing transition metal oxide can be inefficient since at least half of the M(III) ions in the starting transition metal oxide are reduced to M(II) ions that can dissolve in the acid solution and, thus, are extracted out of the crystal structure.

The non-stoichiometric layered alkali nickel metal composite oxide can be treated with a mineral acid at a temperature and for a time suitable to oxidize at least a portion of the nickel (III) to nickel (IV). In embodiments, the mineral acid can be selected from sulfuric acid, nitric acid, phosphoric acid, boric acid, hydrochloric acid, hydrobromic acid, hydrofluoric acid, hydroiodic acid, perchloric acid, and a combination thereof. In embodiments, the mineral acid can be selected from sulfuric acid and nitric acid. In some embodiments, the mineral acid comprises sulfuric acid. In embodiments, the concentration of nickel manganese sulfate in the solution can be in a range of about 0.25M to about 3M, about 0.5M to about 2M, about 0.75M to about 1.5M, about 0.75M to about 1.25M, or about 1M.

The non-stoichiometric layered alkali nickel metal composite oxide can be treated with the mineral acid for a time in a range of about 2 hours to about 84 hours, about 6 hours to about 78 hours, about 12 hours to about 72 hours, about 24 hours to about 66 hours, about 36 hours to about 60 hours, about 42 hours to about 54 hours, or about 48 hours. The treating of the non-stoichiometric alkali nickel metal composite oxide with the mineral acid can be done at any suitable temperature, for example, room temperature (about 20-25° C.).

### Preparation of Stabilized Non-Stoichiometric Layered Alkali Metal-Deficient Nickel-Metal Composite Oxide (Beta-Demetallated Layered Nickel-Metal Composite Oxide)

The methods of the disclosure can further include treating the non-stoichiometric layered alkali metal-deficient nickel-metal composite oxide with an aqueous solution of an alkali metal hydroxide to form the stabilized non-stoichiometric layered alkali metal-deficient nickel-metal composite oxide having a second, different alkali metal inserted into the layers thereof, according to the formula AₓA′ᵥNi_{1+a-z}M_{z}O₂·nH₂O, wherein A, A′, x, v, a, and z are any suitable A, A′, x, v, a, and z disclosed herein, respectively, and specifically, a and z have the same value of a and z as the precursor non-stoichiometric layered alkali metal-deficient nickel-metal composite oxide and A and M are the same as in the precursor non-stoichiometric layered alkali metal-deficient nickel-metal composite oxide. In embodiments, A includes Li or Na; A′ includes K, Cs, or Rb; 0.08≤x<0.2; A′ comprises K, Cs, or Rb, 0.03<v<0.20, M comprises Mn, Al, or Fe, 0.025≤z≤0.5, 0.02<a≤0.2, and 0<n<2.

The aqueous solution of an alkali hydroxide is not particularly limited and can be selected from a potassium salt solution, a rubidium salt solution, a cesium salt solution, or any combination thereof. The concentration of alkali metal salt in the alkaline solution can be any concentration sufficient to achieve substantially complete conversion of the alpha-demetallated layered nickel-metal composite oxide to the beta-demetallated layered nickel-metal composite oxide. As used herein, and unless specified otherwise, “substantially complete conversion” refers to conversion of the alpha-demetallated layered nickel-metal composite oxide to the beta-demetallated layered nickel-metal composite oxide wherein residual alpha-demetallated layered nickel-metal composite oxide is present in an amount of 5 wt. % or less, based on the total weight of the nickel oxide materials. In some embodiments, the concentration of alkali metal hydroxide in the solution can be in a range of about 1M to about 12M, about 3M to about 11M, about 5M to about 10M, or about 6M to about 10M, for example about 9M, about 8.75M, about 8.5M, about 8.25M, about 8M, about 7M, or about 6M. In some embodiments, the alkali metal hydroxide solution includes at least one of potassium hydroxide, cesium hydroxide and rubidium hydroxide, provided at a concentration of about 1M to about 12M. The alpha-demetallated layered nickel-metal composite oxide can be provided as a free-flowing powder when combined with the alkali metal hydroxide solution. The alpha-demetallated layered nickel-metal composite oxide powder and alkali metal hydroxide solution can be combined in a weight ratio of about 10:1 to about 1:5, about 9:1 to about 1:4, about 8:1 to about 1:3, about 7:1 to about 1:2, about 6:1 to about 1:2, about 5:1 to about 1:2, or about 4:1 to about 1:2, or about 3:1 to about 1:1, for example, about 3:1, about 2:1, or about 1:1.

The alpha-demetallated layered nickel-metal composite oxide can be treated with the alkali metal hydroxide solution for a period of time sufficient to ensure that the alpha-demetallated layered nickel-metal composite oxide is fully converted to the beta-demetallated layered nickel-metal composite oxide. The alpha-demetallated layered nickel-metal composite oxide and alkali metal hydroxide solution can be agitated initially for 5 to 15 minutes at ambient temperature to ensure adequate mixing and wetting. Following mixing of the alpha-demetallated layered nickel-metal composite oxide and the alkali metal hydroxide solution, the mixture is held at ambient temperature for 2 to 24 hours. Optionally, the mixture can be stirred during the 2 to 24 hour period. After the 2 to 24 hours, the resulting beta-demetallated layered nickel-metal composite oxide can optionally be washed with water to remove any residual alkali metal hydroxide. Substantially complete conversion to the beta-demetallated layered nickel-metal composite oxide can be confirmed by analyzing the powder X-ray diffraction pattern of the resulting material. For example, for alpha-delithiated layered nickel-manganese composite oxide treated with a potassium hydroxide solution, as the potassium ion and water molecules from the potassium hydroxide solution insert into layers of the alpha-delithiated layered nickel-manganese composite oxide, the intensity of a diffraction peak located at about 18° to 20°2θ in the X-ray diffraction pattern of the alpha-delithiated layered nickel-manganese oxide decreases and very broad peaks appear in the X-ray diffraction pattern of the beta-delithiated layered nickel-manganese composite oxide at about 14.9° to about 16.0°2θ, and about 21.3° to about 22.7°2θ. Thus, at full conversion to the beta-delithiated layered nickel-manganese composite oxide, the powder X-ray diffraction pattern will have broad diffraction peaks at about 10.8° to about 12.0°2θ, about 14.9° to about 16.0°2θ, about 21.3° to about 22.7°2θ, and about 25.3° to about 27.5°2θ having greater intensities than in the powder X-ray diffraction pattern of the alpha-delithiated layered nickel-manganese composite oxide precursor, and there will be no diffraction peak having significant intensity in the range of about 18° to 20°2θ. The resulting beta-demetallated layered nickel-metal composite oxide can be washed repeatedly with deionized water until the pH of the filtrate from washing is about 10. The solid powder can be collected and dried in air at about 70° C. for a period of about 12 to 20 hours.

In embodiments, treating the alpha-demetallated layered nickel-metal composite oxide with an aqueous solution of an alkali metal hydroxide, wherein the alkali metal is different from that of the alpha-demetallated layered nickel-metal composite oxide, forms about 10% or less, by weight, of gamma-nickel oxyhydroxide (γ-NiOOH) as a side product, based on the total weight of the reaction products, for example, about 8% or less, about 6% or less, about 5% or less, about 4% or less, about 3% or less, about 2% or less, about 1% or less, based on the total weight of the solid reaction products. In embodiments, treating the alpha-demetallated layered nickel-metal composite oxide with an aqueous solution of an alkali metal hydroxide preferably results in the formation of less than about 6% by weight of gamma-nickel oxyhydroxide (γ-NiOOH) as a reaction side product.

Thus, the methods of preparing an electrochemically active cathode material having a layered crystal structure according to the disclosure can include:
(a) admixing a nickel metal hydroxide, nickel metal carbonate, a nickel metal nitrate, a nickel metal acetate, a nickel metal citrate, or a combination thereof with a lithium salt to form a reaction mixture;
(b) calcining the reaction mixture to form a non-stoichiometric lithium nickel-metal composite oxide having a layered crystal structure; and
(c) further processing the non-stoichiometric lithium nickel-metal composite oxide to form a beta-delithiated layered nickel-metal composite oxide having a layered crystal structure, the beta-delithiated layered nickel-metal composite oxide layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion M selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, and wherein the electrochemically active cathode material includes about 2.5 mol % to less than about 50 mol % of the second metal ion relative to the total non-alkali metal content.

Alternatively or in addition, the methods of preparing an electrochemically active cathode material having a layered crystal structure, can include:
(a) admixing a nickel nitrate, a metal nitrate, and a lithium nitrate to form a mixture;
(b) annealing the mixture under a flow of oxygen to form a non-stoichiometric lithium nickel-metal composite oxide having a layered crystal structure; and
(c) further processing the non-stoichiometric lithium nickel-metal composite oxide to form a beta-delithiated layered nickel-metal composite oxide having a layered crystal structure, the beta-delithiated layered nickel-metal composite oxide layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to about 25 mol % of the second metal ion relative to the total non-alkali metal content.

The further processing can include (c) oxidizing the non-stoichiometric lithium nickel-metal composite oxide to form a non-stoichiometric delithiated layered nickel-metal composite oxide, the non-stoichiometric delithiated layered nickel-metal composite oxide having a layered crystal structure, the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion M selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to less than about 50 mol % of the second metal ion relative to the total non-alkali metal content, and the non-stoichiometric delithiated layered nickel-metal composite oxide contains fewer lithium ions than the non-stoichiometric lithium nickel-metal composite oxide.

The further processing can further include (d) treating the non-stoichiometric delithiated layered nickel-metal composite oxide with a solution of an alkali metal hydroxide to form a stabilized non-stoichiometric delithiated layered nickel-metal composite oxide having a layered crystal structure, the layered crystal structure of the stabilized non-stoichiometric delithiated layered nickel-metal composite oxide characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion M selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to less than about 50 mol % of the second metal ion relative to the total non-alkali metal content, and a portion of the alkali metal from the alkali metal hydroxide is also located in the interlayer region of the stabilized non-stoichiometric delithiated layered nickel-metal composite oxide.

The methods of the disclosure can include preparing a non-stoichiometric beta-delithiated layered nickel oxide electrochemically active cathode material including the steps of admixing a nickel metal carbonate precursor with a lithium salt to form a mixture and annealing the mixture under oxygen flow, wherein the metal of the nickel metal carbonate comprises Mn, Fe, Al, or a combination thereof. The nickel metal carbonate can be prepared by admixing a NiSO₄ solution and an MSO₄ solution to form a reaction mixture solution and admixing the reaction mixture solution with a NaCO₃ solution to precipitate the nickel metal carbonate, wherein M of the MSO₄ comprises a Mn, Fe, Al, or a combination thereof. The admixing of the reaction mixture solution with the NaCO₃ solution can be performed in the presence of a chelating agent.

The disclosure advantageously provides methods that enhance the formation of beta-demetallated layered nickel-metal composite oxides and thus provide corresponding products with advantageously low levels of contamination whereas prior art techniques at best provide products including high levels of gamma-nickel oxyhydroxide contamination. As described in the examples herein, using lithium nickel oxides doped with metals prepared from prior art solid state techniques to prepare beta-delithiated layered nickel-metal oxides resulted in low yields of the beta-delithiated layered nickel-metal oxides and high levels of gamma-nickel oxyhydrodroxide. For example, as described below, manganese substituted lithium nickel oxides were prepared according to the methods described in U.S. Pat. No. 9,028,564 at 10%, 20%, and 30% manganese substitution. The product powders were delithiated and the resulting delithiated manganese-doped nickel oxide powders were treated with an alkali metal hydroxide solution to attempt to stabilize the delithiated manganese-doped nickel oxide powders. Based on the XRD patterns for the resulting materials, none of the 10%, 20%, or 30% manganese substituted samples prepared by the traditional solid state method included peaks typical of the beta-delithiated layered nickel manganese composite oxides prepared according to methods of the present disclosure. Instead, the dominant phase of the 10% and 20% manganese substituted samples is consistent with gamma-NiOOH and the 30% manganese substituted sample appears to be a derivative of nickel oxides.

Thus, manganese substituted lithium nickel oxide prepared by the traditional solid state methods known in the art is provided as a less homogeneous bulk material which, in turn, leads to increased formation of gamma-NiOOH or other nickel oxide structures after delithiation and stabilization steps. In contrast, as demonstrated in the examples, the methods of the disclosure provide a more homogeneous lithium nickel manganese composite oxide bulk material as the precursor which, in turn, leads to a stabilized beta-delithiated layered nickel manganese composite oxide with less gamma-NiOOH or other nickel oxide structure formation.

### Batteries

Electrochemical cells, or batteries, may be primary or secondary. Primary batteries are meant to be discharged, e.g., to exhaustion, only once and then discarded. Primary batteries are described, for example, in David Linden, Handbook of Batteries (4th ed. 2011). Secondary batteries are intended to be recharged. Secondary batteries may be discharged and recharged many times, e.g., more than fifty times, a hundred times, or more. Secondary batteries are described, for example, in David Linden, Handbook of Batteries (4th ed. 2011). Accordingly, batteries may include various electrochemical couples and electrolyte combinations. Although the description and examples provided herein are generally directed towards primary alkaline electrochemical cells, or batteries, it should be appreciated that the invention applies to both primary and secondary batteries having aqueous, nonaqueous, ionic liquid, and solid state electrolyte systems. Primary and secondary batteries including the aforementioned electrolytes are thus within the scope of this application and the invention is not limited to any particular embodiment.

Referring to FIG. 1, there is shown a primary alkaline electrochemical cell, or battery, 10 including a cathode 12, an anode 14, a separator 16, and a housing 18. Battery 10 also includes a current collector 20, a seal 22, and an end cap 24. The end cap 24 serves as the negative terminal of the battery 10. A positive pip 26 is at the opposite end of the battery 10 from the end cap 24. The positive pip 26 may serve as the positive terminal of the battery 10. An electrolytic solution is dispersed throughout the battery 10. The cathode 12, anode 14, separator 16, electrolyte, current collector 20, and seal 22 are contained within the housing 18. Battery 10 can be, for example, a AA, AAA, AAAA, C, or D size alkaline battery, or a button cell or coin cell.

The housing 18 can be of any conventional type of housing commonly used in primary alkaline batteries and can be made of any suitable base material, for example cold-rolled steel or nickel-plated cold-rolled steel. The housing 18 may have a cylindrical shape. The housing 18 may be of any other suitable, non-cylindrical shape. The housing 18, for example, may have a shape comprising at least two parallel plates, such as a rectangular, square, or prismatic shape. The housing 18 may be, for example, deep-drawn from a sheet of the base material, such as cold-rolled steel or nickel-plated steel. The housing 18 may be, for example, drawn into a cylindrical shape. The housing 18 may have at least one open end. The housing 18 may have a closed end and an open end with a sidewall therebetween. The interior surface of the sidewall of the housing 18 may be treated with a material that provides a low electrical-contact resistance between the interior surface of the sidewall of the housing 18 and an electrode, such as the cathode 12. The interior surface of the sidewall of the housing 18 may be plated, e.g., with nickel, cobalt, and/or painted with a carbon-loaded paint to decrease contact resistance between, for example, the internal surface of the sidewall of the housing 18 and the cathode 12.

The cathode 12 includes at least one electrochemically active cathode material. The electrochemically active cathode material can include a non-stoichiometric alpha-demetallated layered nickel-metal composite oxide and/or a non-stoichiometric beta-demetallated layered nickel-metal composite oxide of the disclosure. In embodiments, when a non-stoichiometric beta-demetallated layered nickel-metal composite oxide is provided as a electrochemically active cathode material, the non-stoichiometric beta-demetallated layered nickel-metal composite oxide comprises less than 5 wt. %, less than 3 wt %, less than 1 wt %, or less than 0.5 wt % residual non-stoichiometric alpha-demetallated layered nickel-metal composite oxide, based on the total weight of the delithiated layered nickel-metal composite oxide electrochemically active cathode material. Similarly, a cell that includes a non-stoichiometric beta-demetallated layered nickel-metal composite oxide, as described herein, is provided with the non-stoichiometric beta-demetallated layered nickel-metal composite oxide ab initio. Thus, the cathode can include a beta-delithiated layered nickel-metal composite oxide of the disclosure. For example, the cathode can include a beta-delithiated layered nickel-metal composite oxide having a layered crystal structure, the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites, wherein the nickel ion sites are occupied by nickel ion or a second metal ion M selected from one or more in the group of manganese ion, aluminum ion, magnesium ion, titanium ion, vanadium ion, chromium ion, copper ion, zinc ion, iron ion, and cobalt ion, wherein a portion of the alkali metal sites are occupied by nickel ion or the second metal ion, wherein the electrochemically active cathode material has a total non-alkali metal content corresponding to a sum of the amounts of the nickel ion and the second metal ion in the electrochemically active cathode material, wherein the electrochemically active cathode material includes about 2.5 mol % to less than about 50 mol % of the second metal ion relative to the total non-alkali metal content, and wherein the electrochemically active cathode material has a gravimetric capacity greater than about 300 mAh/g.

The cathode 12 may also include at least one or more additional electrochemically active cathode materials. The additional electrochemically active cathode material may include manganese oxide, manganese dioxide, electrolytic manganese dioxide (EMD), chemical manganese dioxide (CMD), high power electrolytic manganese dioxide (HP EMD), lambda manganese dioxide, gamma manganese dioxide, and any combination thereof. Other electrochemically active cathode materials include, but are not limited to, silver oxide; nickel oxide, nickel oxyhydroxide; copper oxide; silver copper oxide; silver nickel oxide; bismuth oxide; oxygen; and any combination thereof. The nickel oxyhydroxide can include beta-nickel oxyhydroxide, gamma-nickel oxyhydroxide, intergrowths of beta-nickel oxyhydroxide and/or gamma-nickel oxyhydroxide, and cobalt oxyhydroxide-coated nickel oxyhydroxide. The cobalt oxyhydroxide-coated nickel oxyhydroxide can include cobalt oxyhydroxide-coated beta-nickel oxyhydroxide, cobalt oxyhydroxide-coated gamma-nickel oxyhydroxide, and/or cobalt oxyhydroxide-coated intergrowths of beta-nickel oxyhydroxide and gamma-nickel oxyhydroxide.

In embodiments, the electrochemically active material of cathode 12 comprises at least about 1 wt. %, at least about 2 wt. %, at least about 5 wt. %, at least about 10 wt. %, at least about 15 wt. %, at least about 20 wt. %, at least about 25.wt %, at least about 30 wt. %, at least about 35 wt. %, at least about 40 wt. %, at least about 45 wt. %, at least about 50 wt. %, at least about 55 wt. %, at least about 60 wt. %, at least about 70 wt. %, or at least about 75 wt. %, of the non-stoichiometric beta-demetallated layered nickel-metal composite oxide of the disclosure, based on the total weight of the electrochemically active cathode material. For example, the electrochemically active material of cathode 12 comprises the non-stoichiometric beta-demetallated layered nickel-metal composite oxide of the disclosure in a range of about 10 wt. % to about 90 wt. %, about 10 wt. % to about 80 wt. %, about 20 wt. % to about 70 wt. %, about 30 wt. % to about 60 wt. %, about 40 wt. % to about 60 wt. %, or about 50 wt. %, based on the total weight of the electrochemically active cathode material.

In embodiments, the electrochemically active material of cathode 12 comprises about 40 wt. % to about 60 wt. % of the beta-demetallated nickel-metal composite oxide, based on the total weight of the electrochemically active cathode material and about 60 wt. % to about 40 wt. % of an additional electrochemically active material chosen from one or more in the group of manganese oxide, manganese dioxide, electrolytic manganese dioxide (EMD), chemical manganese dioxide (CMD), high power electrolytic manganese dioxide (HP EMD), lambda manganese dioxide, and gamma manganese dioxide, based on the total weight of electrochemically active cathode material (including both the beta-demetallated nickel-metal composite oxide and the additional electrochemically active material component(s)). A combination of between about 10 wt. % and about 60 wt. %, for example, 20 wt. % or 50 wt. %, of the non-stoichiometric beta-demetallated layered nickel-metal composite oxide with the balance provided by the electrochemically active cathode material comprising electrolytic manganese dioxide (EMD) has been found to provide unexpectedly advantageous battery performance in both high discharge rate applications and low rate discharge applications.

The cathode 12 may include a conductive additive, such as carbon, and optionally, a binder. The cathode 12 may also include other additives. The carbon may increase the conductivity of the cathode 12 by facilitating electron transport within the solid structure of the cathode 12. The carbon may be graphite, such as natural graphite, synthetic graphite, oxidation resistant graphite, graphene, single-walled carbon nanotubes, multi-walled carbon nanotubes, carbon fibers, carbon nanofibers, carbon nanoribbons, carbon nanoplatelets, and mixtures thereof. It is preferred that the amount of carbon in the cathode is relatively low, e.g., less than about 12%, less than about 10%, less than about 9%, less than about 8%, less than about 6%, less than about 5% less than about 3.75%, or even less than about 3.5%, for example from about 3.0% to about 5% by weight or from about 2.0% to about 3.5% by weight. The lower carbon level can enable inclusion of a higher loading of electrochemically active cathode material within the cathode 12 without increasing the volume of the cathode 12 or reducing the void volume (which must be maintained at or above a certain level to prevent internal pressure from rising too high as gas is generated within the cell) within the battery 10. Suitable graphite for use within a battery, e.g., within the cathode, may be, for example, Timrex MX-15, SFG-15, MX-25, all available from Imerys Graphite and Carbon (Bodio, Switzerland). In the case of a highly reactive electrochemically active cathode material such as the non-stoichiometric beta-delithiated layered nickel-metal composite oxide disclosed herein, an oxidation-resistant graphite, for example, SFG-15, SFG-10, and SFG-6, can be used.

The cathode 12 can include an optional binder. As used herein, “binder” refers to a polymeric material that provides cathode cohesion and does not encompass graphite. Examples of optional binders that may be used in the cathode 12 include polyethylene, polyacrylic acid, or a fluorocarbon resin, such as PVDF or PTFE. An optional binder for use within the cathode 12 may be, for example, COATHYLENE HA-1681, available from E. I. du Pont de Nemours and Company (Wilmington, DE, USA). Examples of other cathode additives are described in, for example, U.S. Pat. Nos. 5,698,315, 5,919,598, 5,997,775 and 7,351,499. In some embodiments, the cathode 12 is substantially free of a binder. As used herein, “substantially free of a binder” means that the cathode includes less than about 5 wt. %, less than about 3 wt. %, or less than about 1 wt. % of a binder.

The content of electrochemically active cathode material within the cathode 12 may be referred to as the cathode loading. The loading of the cathode 12 may vary depending upon the electrochemically active cathode material used within, and the size of, the battery 10. For example, a AA battery with a non-stoichiometric beta-demetallated layered nickel-metal composite oxide as the electrochemically active cathode material may have a cathode loading of at least about 6 grams of non-stoichiometric beta-demetallated layered nickel-metal composite oxide. The cathode loading may be, for example, at least about 7 grams of non-stoichiometric beta-demetallated layered nickel-metal composite oxide. The cathode loading may be, for example, between about 7.2 grams to about 11.5 grams of non-stoichiometric beta-demetallated layered nickel-metal composite oxide. The cathode loading may be from about 8 grams to about 10 grams of non-stoichiometric beta-demetallated layered nickel-metal composite oxide. The cathode loading may be from about 8.5 grams to about 9.5 grams of non-stoichiometric beta-demetallated layered nickel-metal composite oxide. The cathode loading may be from about 9.5 grams to about 11.5 grams of non-stoichiometric beta-demetallated layered nickel-metal composite oxide. The cathode loading may be from about 10.4 grams to about 11.5 grams of non-stoichiometric beta-demetallated layered nickel-metal composite oxide. For a AAA battery, the cathode loading may be at least about 3 grams of non-stoichiometric beta-demetallated layered nickel-metal composite oxide electrochemically active cathode material. The cathode loading may be from about 3 grams to about 5 grams of non-stoichiometric beta-demetallated layered nickel-metal composite oxide. The cathode loading may be from about 3.5 grams to about 4.5 grams of non-stoichiometric beta-demetallated layered nickel-metal composite oxide. The cathode loading may be from about 3.9 grams to about 4.3 grams of non-stoichiometric beta-demetallated layered nickel-metal composite oxide. For a AAAA battery, the cathode loading may be from about 1.5 grams to about 2.5 grams of non-beta-demetallated layered nickel-metal composite oxide electrochemically active cathode material. For a C battery, the cathode loading may be from about 27.0 grams to about 40.0 grams, for example about 33.5 grams, of non-stoichiometric beta-demetallated layered nickel-metal composite oxide electrochemically active cathode material. For a D battery, the cathode loading may be from about 60.0 grams to about 84.0 grams, for example about 72.0 grams, of non-stoichiometric beta-demetallated layered nickel-metal composite oxide electrochemically active cathode material.

The cathode components, such as active cathode material(s), carbon particles, binder, and any other additives, may be combined with a liquid, such as an aqueous potassium hydroxide electrolyte, blended, and pressed into pellets for use in the assembly of the battery 10. For optimal cathode pellet processing, it is generally preferred that the cathode pellet have a moisture level in the range of about 2% to about 5% by weight, or about 2.8% to about 4.6% by weight. The pellets, are placed within the housing 18 during the assembly of the battery 10, and are typically re-compacted to form a uniform cathode assembly within the housing 18. The cathode pellet may have a cylindrical shape that includes a central bore. The size of the pellet may vary by the size of the battery, for example AA size, AAA size, AAAA size, C size, and D size, that the pellet will be used within. The central bore may define an inside diameter (ID) of the pellet. The inside diameter of the pellet for a AA battery may be, for example, from about 9.1 mm to about 9.9 mm. The inside diameter of the pellet for a AA battery may be, for example, from about 9.3 mm to about 9.7 mm. The inside diameter of the pellet for a AAA battery may be, for example, from about 6.6 mm to about 7.2 mm. The inside diameter of the pellet for a AAA battery may be, for example, from about 6.7 mm to about 7.1 mm. The inside diameter of the pellet for a AAAA battery may be, for example, from about 5 mm to about 5.5 mm. The inside diameter of the pellet for a C battery may be, for example, from about 16 mm to about 19 mm. The inside diameter of the pellet for a D battery may be, for example, from about 21 mm to about 25 mm. Other cathode pellet geometries and sizes are also contemplated, such as the solid disc-shaped pellets typically found in button cells and coin cells.

The cathode 12 will have a porosity that may be calculated at the time of cathode manufacture. The porosity of the cathode 12 may be from about 20% to about 40%, between about 22% and about 35%, and, for example, about 26%. The porosity of the cathode 12 may be calculated at the time of manufacturing, for example after cathode pellet processing, since the porosity of the cathode 12 within the battery 10 may change over time due to, inter alia, cathode swelling associated with electrolyte wetting of the cathode and discharge of the battery 10. The porosity of the cathode 12 may be calculated as follows. The true density of each solid cathode component may be taken from a reference book, for example Lange's Handbook of Chemistry (16th ed. 2005). The solids weight of each of the cathode components are defined by the battery design. The solids weight of each cathode component may be divided by the true density of each cathode component to determine the cathode solids volume. The volume occupied by the cathode 12 within the battery 10 is defined, again, by the battery design. The volume occupied by the cathode 12 may be calculated by a computer-aided design (CAD) program. The porosity may be determined by the following formula:

$$Cathode Porosity = [ 1 - ( cathode solids volume \div cathode volume ) ] \times 100$$

For example, the cathode 12 of a AA battery may include about 9.0 grams of non-stoichiometric beta-demetallated layered nickel-metal composite oxide and about 0.90 grams of graphite (BNC-30) as solids within the cathode 12. The true densities of the non-stoichiometric beta-demetallated layered nickel-metal composite oxide and graphite may be, respectively, about 4.9 g/cm³ and about 2.15 g/cm³. Dividing the weight of the solids by the respective true densities yields a volume occupied by the non-stoichiometric beta-demetallated layered nickel-metal composite oxide of about 1.8 cm³ and a volume occupied by the graphite of about 0.42 cm³. The total solids volume is about 2.2 cm³. The battery designer may select the volume occupied by the cathode 12 to be about 3.06 cm³. Calculating the cathode porosity per the equation above [1−(2.2 cm³+3.06 cm³)] yields a cathode porosity of about 0.28, or 28%.

The anode 14 can be formed of at least one electrochemically active anode material, a gelling agent, and minor amounts of additives, such as organic and/or inorganic gassing inhibitor. The electrochemically active anode material may include zinc; zinc oxide; zinc hydroxide; metal hydride, such as AB5(H), AB2(H), and A2B7(H); alloys thereof; and any combination thereof.

The content of electrochemically active anode material within the anode 14 may be referred to as the anode loading. The loading of the anode 14 may vary depending upon the electrochemically active anode material used within, and the size of, the battery. For example, a AA battery with a zinc electrochemically active anode material may have an anode loading of at least about 3.3 grams of zinc. The anode loading may be, for example, at least about 3.5 grams, about 3.7 grams, about 3.9 grams, about 4.1 grams, about 4.3 grams, or about 4.5 grams of zinc. The anode loading may be from about 4.0 grams to about 5.5 grams of zinc. The anode loading may be from about 4.2 grams to about 5.3 grams of zinc. For example, a AAA battery with a zinc electrochemically active anode material may have an anode loading of at least about 1.8 grams of zinc. For example, the anode loading may be from about 1.8 grams to about 2.5 grams of zinc. The anode loading may be, for example, from about 1.9 grams to about 2.4 grams of zinc. For example, a AAAA battery with a zinc electrochemically active anode material may have an anode loading of at least about 0.6 grams of zinc. For example, the anode loading may be from about 0.7 grams to about 1.3 grams of zinc. For example, a C battery with a zinc electrochemically active anode material may have an anode loading of at least about 9.3 grams of zinc. For example, the anode loading may be from about 10.0 grams to about 19.0 grams of zinc. For example, a D battery with a zinc electrochemically active anode material may have an anode loading of at least about 30.0 grams of zinc. For example, the anode loading may be from about 30.0 grams to about 45.0 grams of zinc. The anode loading may be, for example, from about 33.0 grams to about 39.5 grams of zinc.

Examples of a gelling agent that may be used within the anode 14 include polyacrylic acids, polyacrylonitriles, starches, starch derivatives, grafted starch materials (e.g., starch grafted polyacrylic acid, starch grafted polyacrylonitrile), salts of polyacrylic acids, polyacrylates, cellulosic derivatives, carboxymethylcellulose, sodium carboxymethylcelluloses, or combinations thereof. Examples of polyacrylic acids include Carbopol® 940 and Carbopol® 934 (available from Lubrizol). Exemplary salts of a polyacrylic acid include Sanfresh AS-100 and Sanfresh AS-150 (available from Sanyo Chemical Industries). The anode may include, for example, from about 0.1% by weight to about 2.5% by weight gelling agent. The anode 14 may include a gassing inhibitor that may include an inorganic material, such as bismuth, tin, or indium. Alternatively, the gassing inhibitor can include an organic compound, such as a phosphate ester, an ionic surfactant or a nonionic surfactant. The electrolyte may be dispersed throughout the cathode 12, the anode 14, and the separator 16. The electrolyte comprises an ionically conductive component in an aqueous solution. The ionically conductive component may be an alkali hydroxide. The hydroxide may be, for example, potassium hydroxide, cesium hydroxide, and any combination thereof. The concentration of the ionically conductive component may be selected depending on the battery design and its desired performance. An aqueous alkaline electrolyte may include a hydroxide, as the ionically conductive component, in a solution with water. The concentration of the alkali hydroxide within the electrolyte may be from about 0.20 to about 0.40, or from about 20% to about 40%, on a weight basis of the total electrolyte within the battery 10. For example, the hydroxide concentration of the electrolyte may be from about 0.25 to about 0.32, or from about 25% to about 32%, on a weight basis of the total electrolyte within the battery 10. The aqueous alkaline electrolyte may also include zinc oxide (ZnO). The ZnO may serve to suppress zinc corrosion within the anode. The concentration of ZnO included within the electrolyte may be less than about 5% by weight of the total electrolyte within the battery 10. The ZnO concentration, for example, may be from about 1% by weight to about 3% by weight of the total electrolyte within the battery 10.

The total weight of the aqueous alkaline electrolyte within a AA alkaline battery, for example, may be from about 3.0 grams to about 4.4 grams. The total weight of the alkaline electrolyte within a AA battery may be, for example, from about 3.3 grams to about 3.8 grams. The total weight of the alkaline electrolyte within a AA battery may be, for example, from about 3.4 grams to about 3.65 grams. The total weight of the aqueous alkaline electrolyte within a AAA alkaline battery, for example, may be from about 1.0 grams to about 2.0 grams. The total weight of the electrolyte within a AAA battery may be, for example, from about 1.2 grams to about 1.8 grams. The total weight of the electrolyte within a AAA battery may be, for example, from about 1.4 grams to about 1.8 grams. The total weight of the electrolyte within a AAAA battery may be from about 0.68 grams to about 1 gram, for example, from about 0.85 grams to about 0.95 grams. The total weight of the electrolyte within a C battery may be from about 11 grams to about 14 grams, for example, from about 12.6 grams to about 13.6 grams. The total weight of the electrolyte within a D battery may be from about 22 grams to about 30 grams, for example, from about 24 grams to about 29 grams.

The separator 16 comprises a material that is wettable or wetted by the electrolyte. A material is said to be wetted by a liquid when the contact angle between the liquid and the surface of the material is less than 90° or when the liquid tends to spread spontaneously across the surface of the material; both conditions normally coexist. The separator 16 may comprise a single layer, or multiple layers, of woven or nonwoven paper or fabric. The separator 16 may include a layer of, for example, cellophane combined with a layer of non-woven material. The separator 16 also can include an additional layer of non-woven material. The separator 16 may also be formed in situ within the battery 10. U.S. Pat. No. 6,514,637, for example, discloses such separator materials, and potentially suitable methods of their application. The separator material may be thin. The separator 16, for example, may have a dry material thickness of less than 250 micrometers (microns). The separator 16 may have a dry material thickness from about 50 microns to about 175 microns. The separator 16 may have a dry material thickness from about 70 microns to about 160 microns. The separator 16 may have a basis weight of about 40 g/m². The separator 16 may have a basis weight from about 15 g/m² to about 40 g/m². The separator 16 may have a basis weight from about 20 g/m² to about 30 g/m². The separator 16 may have an air permeability value. The separator 16 may have an air permeability value as defined in International Organization for Standardization (ISO) Standard 2965. The air permeability value of the separator 16 may be from about 2000 cm³/cm²·min @ 1 kPa to about 5000 cm³/cm²·min @ 1 kPa. The air permeability value of the separator 16 may be from about 3000 cm³/cm²·min @ 1 kPa to about 4000 cm³/cm²·min @ 1 kPa. The air permeability value of the separator 16 may be from about 3500 cm³/cm²·min @ 1 kPa to about 3800 cm³/cm²·min @ 1 kPa.

The current collector 20 may be made into any suitable shape for the particular battery design by any known methods within the art. The current collector 20 may have, for example, a nail-like shape. The current collector 20 may have a columnar body and a head located at one end of the columnar body. The current collector 20 may be made of metal, e.g., zinc, copper, brass, silver, or any other suitable material. The current collector 20 may be optionally plated with tin, zinc, bismuth, indium, or another suitable material presenting a low electrical-contact resistance between the current collector 20 and, for example, the anode 14. The plating material may also exhibit an ability to suppress gas formation when the current collector 20 is contacted by the anode 14.

The seal 22 may be prepared by injection molding a polymer, such as polyamide, polypropylene, polyetherurethane, or the like; a polymer composite; and any combination thereof into a shape with predetermined dimensions. The seal 22 may be made from, for example, Nylon 6,6; Nylon 6,10; Nylon 6,12; Nylon 11; polypropylene; polyetherurethane; co-polymers; composites; and any combination thereof. Exemplary injection molding methods include both the cold runner method and the hot runner method. The seal 22 may contain other known functional materials such as a plasticizer, a crystalline nucleating agent, an antioxidant, a mold release agent, a lubricant, and an antistatic agent. The seal 22 may also be coated with a sealant. The seal 22 may be moisturized prior to use within the battery 10. The seal 22, for example, may have a moisture content of from about 1.0 weight percent to about 9.0 weight percent depending upon the seal material. The current collector 20 may be inserted into and through the seal 22.

The end cap 24 may be formed in any shape sufficient to close the battery. The end cap 24 may have, for example, a cylindrical or prismatic shape. The end cap 24 may be formed by pressing a material into the desired shape with suitable dimensions. The end cap 24 may be made from any suitable material that will conduct electrons during the discharge of the battery 10. The end cap 24 may be made from, for example, nickel-plated steel or tin-plated steel. The end cap 24 may be electrically connected to the current collector 20. The end cap 24 may, for example, make electrical connection to the current collector 20 by being welded to the current collector 20. The end cap 24 may also include one or more apertures, such as holes, for venting any gas pressure due to electrolyte leakage or venting of the battery due to buildup of excessive internal pressure. The current collector 20, the seal 22, and the end cap 24 may be collectively referred to as the end cap assembly.

The batteries of the disclosure can be prepared by incorporating a cathode material into a cathode, incorporating the cathode into the battery, incorporating an anode into the battery, and incorporating an electrolyte into the battery. The cathode material can be prepared as disclosed herein, for example, including admixing a nickel metal carbonate with a lithium salt to form a mixture and annealing the mixture under oxygen flow, wherein the metal, M, of the nickel metal carbonate comprises Mn, Fe, Al, or a combination thereof. The nickel metal carbonate can be prepared by admixing a NiSO₄ solution and an MSO₄ solution to form a reaction mixture and admixing the reaction mixture solution with a NaCO₃ solution to precipitate the nickel metal carbonate, wherein M of the MSO₄ comprises Mn, Fe, Al, or a combination thereof. Admixing of the reaction mixture solution with the NaCO₃ solution can be performed in the presence of a chelating agent.

The electrochemically active cathode material may have a gravimetric capacity from about 300 mAh/g to about 400 mAh/g, from about 310 mAh/g to about 380 mAh/g, from about 320 mAh/g to about 360 mAh/g, when discharged at a low discharge rate (e.g., <C/30 or <C/40) to a 0.6 V cutoff. The battery may have a gravimetric capacity in a voltage window of 1.40V to 1.65V of about 225 mAh/g to about 300 mAh/g, about 225 mAh/g to about 275 mAh/g, or about 250 mAh/g, when included in an alkaline 635 button cell as the sole electrochemically active cathode material discharged at a low discharge rate (e.g., <C/30 or <C/40) to a 1.40 V cutoff).

### Oxygen Evolution Test

To assess the relative effectiveness of partial substitution of Ni by various metal ions on decreasing the reactivity of the beta-demetallated layered nickel-metal composite oxides, the amount of evolved oxygen gas was measured as a function of time. Mixtures containing about 2.5 g active powder (e.g., beta-demetallated layered nickel-metal composite oxide) and about 1.5 g alkaline electrolyte solution (9M KOH) were placed inside laminated foil bags and heat-sealed closed. The bags were placed in an oven and held at various temperatures, for example, 25, 45, 50, or 60° C. for pre-determined periods of time. The total amount of oxygen gas evolved per gram of beta-demetallated layered nickel-metal composite oxide was determined by measuring the relative buoyancy of the foil bag containing the trapped gas using Archimede's principle after storage for 1 hour, 2 hours, 4 hours, 6 hours, 1 day, 2 days, 7 days, 14 days, 21 days, and 28 days. Several samples of beta-demetallated layered nickel-metal composite oxides having representative compositions were evaluated. All samples evolved oxygen gas at 25° C. Results were compared to the oxygen evolution by a control beta-delithiated layered nickel oxide obtained using the same procedure.

### Low Rate Discharge Capacity Test

The electrochemical discharge performance of the electrochemically active cathode materials was evaluated in 635-type alkaline button cells. Button cells were assembled in the following manner. Dried electrochemically active cathode material powder was blended together manually with an oxidation resistant graphite (e.g., Timrex SFG-15 from Timcal) and a KOH electrolyte solution containing 35.3 wt % KOH and 2 wt % zinc oxide in a weight ratio of 75:20:5 using a mortar and pestle to form a wet cathode mix. About 0.45 g of the wet cathode mix was pressed into a nickel grid welded to the bottom of the cathode can of the cell. A disk of porous separator material including a layer of cellophane bonded to a non-woven polymeric layer (e.g., “Duralam” or PDM “PA25”) and saturated with electrolyte solution was positioned on top of the cathode. Additional KOH electrolyte solution was added to the separator to ensure that electrolyte solution fully penetrated the separator and wet the underlying cathode. A polymeric insulating seal was placed on the edge of the anode can. About 2.3 g of anode slurry containing about 68 wt. % zinc alloy particles, about 30 wt. % aqueous alkaline electrolyte solution (29 wt. % KOH, 2 wt. % ZnO), and 2 wt. % of a gelling agent (1.2 wt % Sanfresh AS150 and 0.8 wt % Carbopol® 940) was added to the anode can. Next, the anode can with the polymeric seal was positioned on top of the cathode can and the two cans mechanically crimped together to hermetically seal the cell.

Electrochemical performance, including discharge capacity and discharge energy, was measured at room temperature. All cells were initially rested for 24 hours and then discharged using 3 mA current to 0.6V lower voltage cutoff.

### EXAMPLES

### Example 1

Nickel manganese carbonate precursors of the electrochemically active cathode materials according to the disclosure were prepared.

Two MSO₄ precursor solutions, where M was Ni and Mn, respectively, having concentrations of 2M were prepared by weighing the required amounts into a 400 ml glass beaker while stirring, and diluting with water to 300 ml. Standard conical flasks or measuring cylinders were used to mark up the volume.

A basic precipitating agent solution was also prepared. In a 400 ml beaker, Na₂CO₃ was added to 300 ml water to provide a 2M solution. The basic precipitating agent is preferably prepared just prior to use. Therefore, immediately preceding the start of the reaction, concentrated ammonium hydroxide was added as a chelating agent to help co-precipitation of the nickel manganese carbonate. After the addition of ammonium hydroxide, the beaker is covered with parafilm until use.

Sample amounts for preparing a 10% Mn and 90% Ni Precursor (Ni_{0.9}Mn_{0.1}CO₃):

| | | Mole | | |
|---|---|---|---|---|
| Molecular Formula | Mol Wt | Fraction | Total Volume (ml) | Wt (g) |
| MnSO₄•H₂O | 169.02 | 0.1 | 300 | 10.14 |
| NiSO₄•7H₂O | 280.87 | 0.9 | 300 | 151.67 |
| Na₂CO₃ | 105.99 | 2 | 300 | 63.59 |
| NH₄OH (28%) | 35.04 | 15 | 7.8 | |

In a 1 L beaker, 150 ml of DI water is preheated at 60° C., with stirring. The metal, MSO₄, solutions are added at 2.5 ml/min for 1 min. Then, without stopping the addition of the metal solutions, the basic precipitating agent solution was added at a rate of 1.8 ml/min. The temperature was adjusted during the reaction to maintain it at 60° C. After 2 hours, the reaction was stopped by removing the heat and stopping addition of the base solution. Stirring was continued for an additional 10 minutes. The mixture was left to stand for 30 minutes to allow the precipitate to settle. The supernatant was discarded, and the nickel-manganese carbonate precipitate was transferred to a 2.5 L bucket. The bucket was filled with fresh DI water and thoroughly stirred. Stirring was stopped and the precipitate allowed to settle (about 30 minutes). The supernatant was discarded. The bucket was again filled with fresh DI water and thoroughly stirred. The mixture was left to stand for 30 minutes to allow the precipitate to settle. The supernatant was discarded. Additional washes were continued until the pH of the supernatant is decreased to about 7 (about three total washes). The precipitate was collected by vacuum filtration.

The resulting nickel-manganese carbonate precursors were spread in a thin layer in a petri dish or other glass container and were dried in a fume hood overnight (˜12 hours) under good air flow at ambient temperature (˜20-25° C.). The dried powder was sieved using 45 μm mesh. The resulting powder was dried at a temperature of 110° C. by placing containers of the powder in a vacuum heating oven preset to 110° C. for two to three hours. The resulting powder was again sieved using 45 μm mesh.

Ni₁₋ₓMnₓCO₃ compounds with different Ni/Mn stoichiometry can be prepared in the same way, by varying the mole fraction of the MnSO₄·H₂O and NiSO₄·7H₂O precursor solutions.

Thus, Example 1 demonstrates the preparation of nickel manganese carbonate precursors for preparing the electrochemically active cathode materials of the disclosure.

### Example 2

Lithium nickel manganese oxide precursors of the electrochemically active cathode material were prepared.

40 g of a nickel manganese carbonate precursor, Ni_{0.85}Mn_{0.15}CO₃, prepared in accordance with the method of Example 1 was combined with 12.51 g Li₂CO₃ and 0.154 g K₂CO₃ in a mortar and mixed together thoroughly using a pestle to ensure the mixture was homogeneous. The mixture was transferred to a ceramic crucible and placed inside an oven for annealing under oxygen flow (0.6 L/min). The crucible was gradually heated at a rate of 5° C./min to a temperature of 925° C. The crucible was held at 925° C. for 24 hours. After 24 hours, the crucible was allowed to gradually cool down to room temperature (˜20-25° C.) to provide a non-stoichiometric lithium nickel manganese composite oxide (confirmed by ICP).

Thus, Example 2 demonstrates the preparation of non-stoichiometric lithium nickel manganese composite oxide precursors for preparing the electrochemically active cathode materials of the disclosure.

### Example 3

Alpha-delithiated layered nickel manganese composite oxide electrochemically active cathode material was prepared.

To a clean, dry, beaker was added 300 mL of 2M H₂SO₄. 30 g of a non-stoichiometric lithium nickel manganese composite oxide prepared in accordance with the method of Example 2 was added to the beaker and the resulting mixture was stirred at room temperature (˜20-25° C.) for 48 hours. After 48 hours, the resulting solid was washed with DI water multiple times (e.g., at least 3 washes), the powder was collected by filtration and dried at 50° C. to provide a non-stoichiometric alpha-delithiated manganese nickel composite oxide (confirmed by comparison with known XRD pattern).

Thus, Example 3 demonstrates the preparation of an alpha-delithiated layered nickel manganese composite oxide electrochemically active cathode material of the disclosure.

### Example 4

Beta-delithiated layered nickel manganese composite oxide electrochemically active cathode material was prepared.

10 g of a non-stoichiometric alpha-delithiated nickel manganese composite oxide powder prepared according to the method of Example 3 was added to a clean, dry, plastic beaker. 3.3 g of 9M KOH solution was added to the beaker with vigorous stirring using a spatula. The resulting mixture was left at room temperature (˜20-25° C.) for 24 hours. The resulting solid was washed with DI water multiple times (e.g., at least 3 times) and dried at 50° C. to provide a non-stoichiometric beta-delithiated manganese nickel composite oxide (confirmed by comparison with known XRD pattern).

Thus, Example 4 demonstrates the preparation of a beta-delithiated layered nickel manganese composite oxide electrochemically active cathode material of the disclosure.

### Example 5

Beta-delithiated layered nickel manganese composite oxide electrochemically active cathode materials of the disclosure were prepared according to the procedures of Examples 1-4. The prepared electrochemically active cathode materials are described in Table 1, below. The percent manganese and percent nickel are based on the total amount of manganese and nickel. Three comparative examples including known electrochemically active materials are provided as C1, C2, and C3. A fourth comparative example comprising an electrochemically active cathode material according to the disclosure contaminated with about 25 wt % gamma-NiOOH is included as C4. Gamma-NiOOH content was determined by preparing a calibration curve by mixing known quantities of beta-delithiated layered nickel metal oxide and gamma-NiOOH and using the relative peak intensity ratios for the strongest XRD peak for each phase (˜37.3° for beta-delithiated layered nickel metal oxide and ˜12.5° for gamma-NiOOH) as representative.

TABLE 1

| | Mn mole | Ni mole |
|---|---|---|
| | fraction | fraction |
| | relative to | relative to |
| Sample ID | total TM (%) | total TM (%) |
| 1 Li_{0.042}K_{0.094}Ni_{1.044}Mn_{0.055}O₂•nH₂O | 5 | 95 |
| 2 Li_{0.058}K_{0.118}Ni_{0.941}Mn_{0.086}O₂•nH₂O | 8 | 92 |
| 3 Li_{0.087}K_{0.120}Ni_{0.947}Mn_{0.089}O₂•nH₂O | 9 | 91 |
| 4 Li_{0.032}K_{0.095}Ni_{0.860}Mn_{0.167}O₂•nH₂O | 16 | 84 |
| C1 Beta-delithiated layered nickel oxide | 0 | 100 |
| Li_{0.072}K_{0.114}Ni_{1.110}O₂•nH₂O | | |
| C2 Gamma nickel oxyhydroxide | 0 | 100 |
| C3 Electrolytic Manganese Dioxide | 100 | 0 |
| (EMD) | | |
| C4 Li_{0.075}K_{0.123}Ni_{0.835}Mn_{0.156}O₂•nH₂O | 16 | 84 |
| (with about 25 wt % gamma-NiOOH) | | |

ICP analysis of Samples (mol fraction):

| Sample ID | K | Li | Mn | Ni |
|---|---|---|---|---|
| 1 | 0.094 | 0.042 | 0.055 | 1.044 |
| 2 | 0.118 | 0.058 | 0.086 | 0.941 |
| 3 | 0.120 | 0.087 | 0.089 | 0.947 |
| 4 | 0.095 | 0.032 | 0.167 | 0.860 |
| C4 | 0.123 | 0.075 | 0.156 | 0.835 |

The XRD patterns for Samples 1-4 are shown in FIG. 2. The spectra shown in FIG. 2 are, from the bottom up, Sample 1, Sample 2, Sample 3, and Sample 4. As can be seen in FIG. 2, each of Samples 1-4 have an X-ray diffraction pattern (XRD) comprising a first peak from 14.9°2θ to 16.0°2θ; a second peak from 21.3°2θ to 22.7°2θ; a third peak from 37.1°2θ to 37.4°2θ; a fourth peak from 43.2°2θ to 44.0°2θ; a fifth peak from 59.6°2θ to 60.6°2θ; and a sixth peak from 65.4°2θ to 65.9°2θ consistent with the demonstrated XRD pattern for the beta-delithiated layered nickel oxide described in U.S. Pat. No. 10,910,647. The XRD patterns did not include any segregated manganese phases (e.g., LiMn₂O₄, Li₂MnO₃, or Mn₃O₄), any MnO₂ polytypes (such as MnO₂ spinel, ramsdellite, or pyrolusite phases), or any amorphous material, indicating that the Samples are all a single, homogeneous, phase.

Energy Dispersive X-ray Spectroscopy (EDAX) images were obtained for each of Sample 1, Sample 2, Sample 3, and Sample 4. EDAX images showed homogenous distribution of each of manganese, oxygen, nickel, and potassium ions for each of the sample materials. EDAX can be performed on a GeminiSEM 300 or equivalent from Zeiss instruments. Samples can be prepared by sprinkling electrochemically active cathode powder on the conductive carbon base and then coating with Iridium to enhance surface conductivity.

The low rate discharge capacity was determined according to the Low Rate Discharge Capacity Test and reported in Table 2, below. As shown in FIG. 4B, while the overall discharge capacity of a beta-delithiated layered nickel manganese oxide composite oxide contaminated with a high amount of gamma-NiOOH present (C4) is similar to a comparable beta-delithiated layered nickel manganese oxide composite oxide without the high amount of gamma-NiOOH contamination (Sample 4), the discharge curves indicate that cells including Sample 4 have more high voltage capacity (>1.4V) and cells including sample C4 have more low voltage capacity (≤1V). Table 2 further includes the calculated volumetric energy density (described above) as well as the capacity and energy values derived from the 635 button cells used in the Low Rate Discharge Capacity Test. As mentioned above, volumetric energy density can be calculated according to the following formula:

$$Volumetric Energy Density ( Wh / L ) = Dch Energy ( mWh / g ) \times True Density ( g / {cm}^{3} ) .$$

TABLE 2

| | Dch Capacity | Dch Energy | True | Vol. Energy |
|---|---|---|---|---|
| Sample | (mAh/g) @ | (mWh/g) @ | Density | Density |
| ID | 0.6 V | 0.6 V | (g/cm³) | (Wh/L) |
| 1 | 351 | 510 | 4.4 | 2244 |
| 2 | 347 | 478 | 4.4 | 2103 |
| 3 | 348 | 463 | 4.4 | 2037 |
| 4 | 327 | 476 | 4.4 | 2094 |
| C1 | 362 | 533 | 4.4 | 2345 |
| C2 (Gamma | 330 | 447 | 3.9 | 1743 |
| NiOOH) | | | | |
| C3 | 320 | 389 | 4.4 | 1712 |
| C4 | 327 | 428 | 4.4 | 1883 |

Thus, Example 5 describes beta-delithiated layered nickel-manganese composite oxide electrochemically active cathode materials of the disclosure and use of same in alkaline button cells.

### Example 6

Preparation of a lithium manganese nickel oxide composite material having about 20 mol. % manganese relative to the total amount of manganese and nickel.

A beta-delithiated layered nickel manganese composite oxide electrochemically active cathode material of the disclosure was prepared according to the procedures of Examples 1-4. The beta-delithiated layered nickel manganese composite oxide material included about 20 mol. % Mn and the structure was confirmed by XRD. The resulting material also included about 15 wt % gamma-NiOOH as a side product. The prepared material (including the gamma-NiOOH contaminant) was incorporated into a 635 button cells as described in the Low Rate Discharge Capacity Test. The low rate discharge capacity was determined to be 320 mAh/g and the discharge energy was determined to be 409 mWh/g according to the Low Rate Discharge Capacity Test. The volumetric energy density was estimated according to the formulas provided above and was determined to be 1800 Wh/L. It is believed that the beta-delithiated layered nickel manganese composite oxide, when provided as the sole electrochemically active cathode material (i.e., upon removal of gamma-NiOOH contamination and/or optimization of the synthetic method) in a 635 button cell will have a volumetric energy density of 1900 Wh/L or more, when tested according to the Low Rate Discharge Capacity Test.

Thus, Example 6 describes a composite oxide material of the disclosure including about 20 mol. % Mn and the use of same in alkaline button cells.

### Example 7

Beta-delithiated layered nickel manganese composite oxide electrochemically active cathode materials of the disclosure were prepared using a solid-state nitrate method.

Manganese substituted lithium nickel oxides (LNO) were prepared by mixing nickel nitrate hexahydrate (Ni(NO₃)·6H₂O) with stoichiometric amounts of a manganese nitrate hydrate (Mn(NO₃)₂·xH₂O, Aldrich, 99.8%) and lithium hydroxide monohydrate (LiNO₃, Aldrich, >99%) to obtain the target atom ratios required for the desired compositions.

For example, to prepare a 13% Mn containing lithium nickel manganese composite oxide, 27.01 g of a nickel nitrate hexahydrate, 1.85 g of manganese nitrate, and 7.12 g of lithium nitrate added to a mortar and mixed together thoroughly using a pestle to ensure the mixture was homogeneous. The mixture was transferred to a ceramic crucible and placed inside an oven for annealing under oxygen flow (0.6 L/min). The crucible was gradually heated at a rate of 5° C./min to a temperature of 875° C. The crucible was held at 875° C. for 15 hours. After 15 hours, the crucible was allowed to gradually cool down to room temperature (˜20-25° C.) to provide a non-stoichiometric lithium nickel manganese composite oxide.

The non-stoichiometric lithium nickel manganese composite oxides were treated in accordance with Examples 3 and 4 to provide a non-stoichiometric beta-delithiated layered nickel manganese composite oxide. The final non-stoichiometric beta-delithiated layered nickel manganese composite oxides had Mn content somewhat higher than the initial value targeted due to dissolution and solubilization of more nickel than manganese during the acid treatment step (described in Example 3). The actual content of each metal was determined by ICP analysis. The structures of the materials were confirmed by XRD. The samples prepared by this method were used in 635 button cells prepared and tested in accordance with the Low Rate Discharge Test. The resulting capacity and energy of the cells are provided below in Table 3.

TABLE 3

| Mn mol. % in Mn | Structure after | | | | |
|---|---|---|---|---|---|
| substituted | stabilization | | | | Vol. Energy |
| lithium nickel | in accordance | Dch Capacity | Dch Energy | True Density | Density |
| oxide | with Example 4 | (mAh/g) @ 0.6 V | (mWh/g) @ 0.6 V | (g/cm³) | (Wh/L) |
| 13 | Beta-delithiated | 336 | 444 | 4.4* | 1954 |
| | layered nickel | | | | |
| | manganese | | | | |
| | composite | | | | |
| | oxide | | | | |
| 26 | Beta-delithiated | 319 | 406 | 4.4* | 1786 |
| | layered nickel | | | | |
| | manganese | | | | |
| | composite | | | | |
| | oxide | | | | |
| 36 | γ-NiOOH | 300 | 378 | 3.9 | 1474 |

*expected true density

The non-stoichiometric beta-delithiated layered nickel manganese composite oxide having 26 mol. % Mn included about 5 wt. % gamma-NiOOH contamination. It can be seen that the solid-state nitrate method can be used to prepare lithium nickel manganese composite oxide materials which can, in turn be used to prepare alpha-delithiated layered nickel manganese composite oxides and, in some cases, beta-delithiated layered nickel manganese composite oxides. As the amount of manganese substitution increases, e.g., approaching and/or beyond about 30 mol % (based on the total non-alkali metal content), our observations show that the composite oxides formed by the solid-state nitrate method are unable to be converted to a beta-delithiated layered nickel manganese composite oxide structure and instead collapse into a gamma-NiOOH type structure. Further, without intending to be bound by theory, it is believed that as the amount of manganese substitution increases, e.g., beyond about 20 mol % or 25 mol % (based on the total non-alkali metal content) in the composite oxides prepared by the solid-state nitrate method, materials having a structure consistent with the beta-delithiated layered nickel manganese composite oxide can be prepared but the increased amount of manganese leads to decreased energy and volumetric energy density.

Thus, Example 7 describes beta-delithiated layered nickel-manganese composite oxide electrochemically active cathode materials of the disclosure and comparative examples and use of same in alkaline button cells.

### Comparative Example 1

Preparation of a lithium manganese nickel oxide composite material having 50 mol. % manganese relative to the total amount of manganese and nickel.

40 g of a nickel manganese carbonate precursor, Ni_{0.5}Mn_{0.5}CO₃, prepared in accordance with the method of Example 1 was mixed with 12.51 g Li₂CO₃ and 0.154 g K₂CO₃ in a mortar and were mixed together thoroughly using a pestle to ensure the mixture was homogeneous. The mixture was transferred to a ceramic crucible and placed inside an oven for annealing under oxygen flow (0.6 L/min). The crucible was gradually heated at a rate of 5° C./min to a temperature of 925° C. The crucible was held at 925° C. for 24 hours. After 24 hours, the crucible was allowed to gradually cool down to room temperature (˜20-25° C.) to provide a lithium nickel manganese oxide, LiNi_{0.5}Mn_{0.5}O₂.

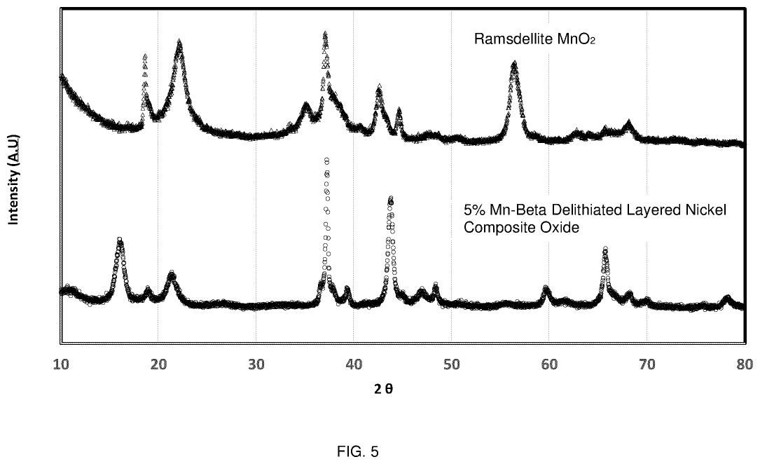

To a clean, dry, beaker was added 300 mL of 2M H₂SO₄. 30 g of the LiNi_{0.5}Mn_{0.5}O₂ was added to the beaker and the resulting mixture was stirred at room temperature (˜20-25° C.) for 48 hours. After 48 hours, the resulting solid was washed with DI water multiple times (e.g., at least 3 washes), the powder was collected by filtration and dried at 50° C. The resulting material did not have a layered structure as determined by XRD. Instead, a structure consistent with ramsdellite MnO₂ was formed. FIG. 5 shows XRD structures for ramsdellite MnO₂ and a 5% Mn containing beta delithiated layered nickel composite oxide of the disclosure. While a ramsdellite structure may be suitable for lithium ion applications, such a structure is undesirable for alkaline battery applications.

Thus, Comparative Example 1 demonstrates that when z is 0.5 or more a layered material having a formula A₁₋ₐNi_{1-z+a}M_{z}O₂, is not formed.

### Comparative Example 2

Preparation of manganese-doped lithium nickel oxide using a traditional solid state method and delithiation of same.

Manganese substituted lithium nickel oxides were prepared according to the methods described in U.S. Pat. No. 9,028,564. 35 g of spherical β-nickel oxyhydroxide (NiOOH) was mixed with stoichiometric amounts of a manganese oxide (Mn₃O₄, Aldrich 99.8%) and lithium hydroxide monohydrate (LiOH·H₂O) to obtain the target atom ratios required for the desired composition. The target compositions had 10%, 20%, and 30% manganese substitution.

All the mixtures were mixed by high-energy milling and then heated to 210° C. at a ramp rate of 0.5° C./min, held for 16-20 hours at temperature in flowing O₂ and allowed to furnace cool. The mixtures were re-milled and re-heated in flowing O₂, first to 150° C. (2.5° C./min ramp rate) and held for 30 minutes, next to 350° C. (4° C./min ramp rate) and held for 3 hours, and finally to 800° C. (4° C./min ramp rate) and held for 48 hours and finally allowed to furnace cool to ambient room temperature in flowing O₂.

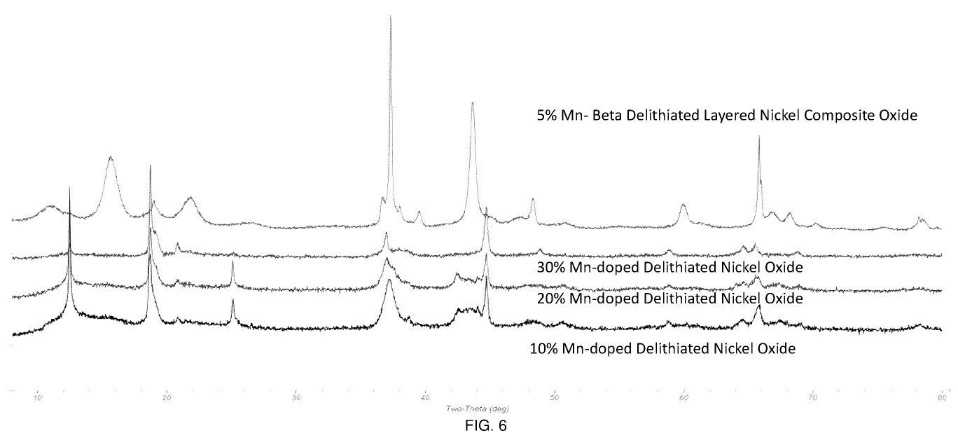

The product powders were re-milled to break up aggregates. The product powders were delithiated as described in Example 3. The resulting delithiated manganese-doped nickel oxide powders were treated with an alkali metal hydroxide solution as described in Example 4 to attempt to stabilize the delithiated manganese-doped nickel oxide powders. The XRD patterns for the resulting solids are shown in FIG. 6. As shown in FIG. 6, none of the 10%, 20%, or 30% manganese substituted samples prepared by the traditional solid state method include peaks typical of the beta-delithiated layered nickel manganese composite oxides prepared according to methods of the present disclosure. Instead, the dominant phase of the 10% and 20% manganese substituted samples is consistent with gamma-NiOOH and the 30% manganese substituted sample appears to be a derivative of nickel oxides.

Thus, Comparative Example 2 suggests that the manganese substituted lithium nickel oxide prepared by the traditional solid state methods known in the art provide a less homogeneous structure which, in turn, without intending to be bound by theory, is believed to lead to the formation of gamma-NiOOH or other nickel oxide structures after delithiation and stabilization steps. In contrast, as demonstrated in Example 5 and FIG. 2, the methods of the disclosure provide a more homogeneous lithium nickel manganese composite oxide which, in turn, leads to a stabilized beta-delithiated layered nickel manganese composite oxide with less gamma-NiOOH or other nickel oxide structure formation.

1. A battery comprising:
an anode;
a cathode; and
a separator between the anode and the cathode;
wherein the cathode comprises an electrochemically active cathode material comprising a beta-delithiated layered nickel-metal composite oxide having a layered crystal structure, the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites,
wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion,
wherein a portion of the alkali metal sites are occupied by nickel ion or the second metal ion,
wherein the electrochemically active cathode material has a total non-alkali metal content corresponding to a sum of the amounts of the nickel ion and the second metal ion in the electrochemically active cathode material,
wherein the electrochemically active cathode material includes about 2.5 mol % to about 25 mol % of the second metal ion relative to the total non-alkali metal content and
wherein the electrochemically active cathode material has a volumetric energy density greater than about 1900 Wh/L.

2. The battery of claim 1, wherein the electrochemically active cathode material includes about 2.5 mol % to about 20 mol % of the second metal ion relative to the total non-alkali metal content.

3. (canceled)

4. (canceled)

5. The battery of claim 1, wherein the beta-delithiated layered nickel-metal composite oxide has a formula AₓA′ᵥNi_{1+a-z}M_{z}O₂·nH₂O, wherein:
$$0.08 \leq x \leq 0.2 ;$$
$$0.02 \leq a \leq 0.2 ;$$
$$0.03 \leq v \leq 0.2 ;$$
$$0.025 \leq z \leq 0.5 ;$$
0<n<2; and
A is selected from Li, Na, and a combination thereof;
A′ is selected from Na, K, Rb, Cs, and a combination thereof;
M is the second metal ion and is selected from one or more in the group of manganese ion, aluminum ion, magnesium ion, titanium ion, vanadium ion, chromium ion, copper ion, zinc ion, iron ion, and cobalt ion.

6. (canceled)

7. The battery of claim 1, wherein the second metal ion, M, comprises manganese ion, iron ion, or a combination thereof.

8. (canceled)

9. The battery of claim 5, wherein A comprises Li.

10. (canceled)

11. The battery of claim 1, wherein the electrochemically active cathode material has a volumetric energy density greater than about 1950 Wh/L.

12. The battery of claim 1, wherein the electrochemically active cathode material has a gravimetric capacity of greater than about 300 mAh/g.

13. (canceled)

14. The battery of claim 1, wherein the electrochemically active cathode material further comprises a second electrochemically active cathode material selected from one or more in the group of manganese oxide, manganese dioxide, electrolytic manganese dioxide (EMD), chemical manganese dioxide (CMD), high power electrolytic manganese dioxide (HP EMD), lambda manganese dioxide, and gamma manganese dioxide.

15. (canceled)

16. (canceled)

17. (canceled)

18. The battery of claim 1, wherein the electrochemically active material comprises at least about 1 wt. %, of the beta-delithiated layered nickel-metal composite oxide.

19. The battery of claim 1, wherein the beta-delithiated layered nickel-metal composite oxide generates less than 3 cc of oxygen per gram of beta-delithiated layered nickel-metal composite oxide over at least 28 days.

20. The battery of claim 1, wherein the electrochemically active cathode material has a gravimetric capacity greater than about 200 mAh/g at voltages between 1.4 V and 1.65 V.

21. (canceled)

22. The battery of claim 1, wherein the electrochemically active cathode material has a D50 particle size of less than 8 microns.

23. An electrochemically active cathode material, comprising:
a beta-delithiated layered nickel-metal composite oxide having a layered crystal structure the layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites,
wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion,
wherein a portion of the alkali metal sites are occupied by nickel ion or the second metal ion,
wherein the electrochemically active cathode material has a total non-alkali metal content corresponding to a sum of the amounts of the nickel ion and the second metal ion in the electrochemically active cathode material, and
wherein the electrochemically active cathode material includes about 2.5 mol % to about 25 mol % of the second metal ion relative to the total non-alkali metal content.

24. (canceled)

25. (canceled)

26. (canceled)

27. (canceled)

28. (canceled)

29. (canceled)

30. (canceled)

31. The electrochemically active cathode material according to claim 23, wherein the electrochemically active cathode material has a formula AₓA′ᵥNi_{1+a-z}M_{z}O₂·nH₂O, wherein:
$$0.08 \leq x \leq 0.2 ;$$
$$0.02 \leq a \leq 0.2 ;$$
$$0.03 \leq v \leq 0.2 ;$$
$$0.025 \leq z \leq 0.5 ;$$
0<n<2; and
A is selected from the group consisting of Li, Na, and a combination thereof;
A′ is selected from the group consisting of Na, K, Rb, Cs, and a combination thereof;
M is the second metal ion and is selected from one or more in the group of manganese ion, aluminum ion, magnesium ion, titanium ion, vanadium ion, chromium ion, copper ion, zinc ion, iron ion, and cobalt ion.

32. (canceled)

33. (canceled)

34. (canceled)

35. (canceled)

36. A method of preparing an electrochemically active cathode material having a layered crystal structure, the method comprising:
(a) admixing a nickel metal hydroxide, nickel metal carbonate, a nickel metal nitrate, a nickel metal acetate, a nickel metal citrate, or a combination thereof with a lithium salt to form a reaction mixture;
(b) calcining the reaction mixture to form a non-stoichiometric lithium nickel-metal composite oxide having a layered crystal structure; and
(c) further processing the non-stoichiometric lithium nickel-metal composite oxide to form a beta-delithiated layered nickel-metal composite oxide having a layered crystal structure, the beta-delithiated layered nickel-metal composite oxide layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites,
wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion,
wherein a portion of the alkali metal sites are occupied by nickel ion or the second metal ion,
wherein the electrochemically active cathode material has a total non-alkali metal content corresponding to a sum of the amounts of the nickel ion and the second metal ion in the electrochemically active cathode material,
wherein the electrochemically active cathode material includes about 2.5 mol % to about 25 mol % of the second metal ion relative to the total non-alkali metal content.

37. (canceled)

38. (canceled)

39. (canceled)

40. (canceled)

41. (canceled)

42. (canceled)

43. A method of preparing the electrochemically active cathode material of claim 23, comprising:
admixing a nickel metal carbonate with a lithium salt to form a mixture and annealing the mixture under oxygen flow,
wherein the metal of the nickel metal carbonate comprises Mn, Fe, or a combination thereof.

44. The method of claim 43, further comprising preparing the nickel metal carbonate by admixing a NiSO₄ solution and an MSO₄ solution to form a reaction mixture solution; and
admixing the reaction mixture solution with a NaCO₃ solution to precipitate the nickel metal carbonate,
wherein M of the MSO₄ comprises Mn, Fe, or a combination thereof.

45. (canceled)

46. A method of preparing a battery comprising:
preparing a cathode material comprising admixing a nickel metal carbonate with lithium salt to form a mixture and annealing the mixture under oxygen flow, wherein the metal, M, of the nickel metal carbonate comprises Mn, Fe, or a combination thereof;
incorporating the cathode material into a cathode;
incorporating the cathode into the battery;
incorporating an anode into the battery; and
incorporating an electrolyte into the battery.

47. (canceled)

48. (canceled)

49. A method of preparing an electrochemically active cathode material having a layered crystal structure, the method comprising:
(a) admixing a nickel nitrate, a metal nitrate, and a lithium nitrate to form a mixture;
(b) annealing the mixture under a flow of oxygen to form a non-stoichiometric lithium nickel-metal composite oxide having a layered crystal structure; and
(c) further processing the non-stoichiometric lithium nickel-metal composite oxide to form a beta-delithiated layered nickel-metal composite oxide having a layered crystal structure, the beta-delithiated layered nickel-metal composite oxide layered crystal structure characterized by a lattice including (i) a plurality of NiO₂-type layers, the NiO₂-type layers including octahedral nickel ion sites, and (ii) an interlayer region between the NiO₂-type layers, the interlayer region including alkali metal sites,
wherein the nickel ion sites are occupied by nickel ion or a second metal ion selected from one or more in the group of manganese ion, aluminum ion, magnesium ion, titanium ion, vanadium ion, chromium ion, copper ion, zinc ion, iron ion, and cobalt ion,
wherein a portion of the alkali metal sites are occupied by nickel ion or the second metal ion,
wherein the electrochemically active cathode material has a total non-alkali metal content corresponding to a sum of the amounts of the nickel ion and the second metal ion in the electrochemically active cathode material,
wherein the electrochemically active cathode material includes about 2.5 mol % to about 25 mol % of the second metal ion relative to the total non-alkali metal content.

50. (canceled)

51. (canceled)

52. (canceled)

53. (canceled)

54. (canceled)

55. A method of preparing a battery comprising:
preparing a cathode material comprising admixing a nickel nitrate, a metal nitrate, and a lithium salt to form a mixture and annealing the mixture under oxygen flow, wherein the metal, M, of the nickel metal carbonate comprises Mn, Fe, or a combination thereof;
incorporating the cathode material into a cathode;
incorporating the cathode into the battery;
incorporating an anode into the battery; and
incorporating an electrolyte into the battery.
